(19) United States
(12) Patent Application Publication
(10) Pub. No.: US 2026/0211542 A1
(43) Pub. Date: Jul. 23, 2026

(54) GENERATION AND UPDATING OF A CANVAS VIRTUAL SPACE

(71) Applicant: Salesforce, Inc., San Francisco, CA (US)

(72) Inventors: Parker Kuncl, Seattle, WA (US); Sky Chen, Palo Alto, CA (US); Samuel Sharaf, Palo Alto, CA (US)

(21) Appl. No.: 19/031,057

(22) Filed: Jan. 17, 2025

(51) Int. Cl. G06F 3/04845; G06F 3/0482

(52) U.S. Cl. CPC G06F 3/04845; G06F 3/0482

(57) ABSTRACT

A user may input text or select a suggested prompt via a user interface. Based on the text or the suggested prompt, one or more models may identify a responsive topic and different aspects or categories of the topic. The aspects/categories may be represented as tiles that include content associated with the tile. The tiles and the associated content may be dynamically rendered in a canvas virtual space that is accessible to the user. The canvas virtual space may be dynamically updated based on requests from the user and/or the identification of additional data that is deemed to be relevant to the topic. As a result, the user can view relevant an up to date content that is responsive to their inputted text or suggested prompt via the canvas virtual space, without having to navigate to different resources (e.g., websites, internal documents, external documents, etc.) to obtain such information.

### TECHNICAL FIELD

Communication platforms are becoming increasingly more popular for organizations and users to facilitate work-related communications. Users of such communication platforms can communicate with other users via channels, direct messages, and/or other virtual spaces. In some examples, a communication platform or channels (or any other virtual space) within the communication platform may include a canvas that provides a means for curating, organizing, and sharing collections of information between users. In such instances, various members of the communication platform and/or channel may be tasked with identifying content to be included within the canvas, manually inputting the content into the canvas, and/or maintaining the content found on the canvas. Accordingly, such manual tasks may result in inaccurate data, delays in updating such data, and inefficient use of user time.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2A illustrates a user interface for a group-based communication system for certain examples.

FIG. 2B illustrates a user interface for multimedia collaboration sessions within the group-based communication system for certain examples.

FIG. 2C illustrates a user interface for inter-organization collaboration within the group-based communication system for certain examples.

FIG. 2D illustrates a user interface for collaborative documents within the group-based communication system for certain examples.

FIG. 3A depicts a user interface for workflows within a group-based communication system.

FIG. 3B depicts a block diagram for carrying out certain examples, as discussed herein.

FIG. 4 illustrates an example architecture utilized to generate and maintain a canvas virtual space utilizing machine learning and/or generative artificial intelligence (AI).

FIG. 5 illustrates an example user interface associated with a communication platform displaying a suggested query/question and an input field utilized to generate a canvas virtual space.

FIG. 6 illustrates an example user interface associated with a communication platform displaying a canvas virtual space associated with a specific user.

FIG. 7 illustrates an example user interface associated with a communication platform displaying a file upload operation in association with a canvas virtual space.

FIG. 8A illustrates an example user interface associated with a communication platform displaying varying levels of granularity of information.

FIG. 8B illustrates an example user interface associated with a communication platform displaying varying levels of granularity of information.

FIG. 9 illustrates an example diagram indicating the generation of a canvas virtual space.

FIG. 10 is a flow diagram illustrating an example process of generating and maintaining a canvas virtual space.

### DETAILED DESCRIPTION

As discussed above and with respect to content that is maintained in a plurality of different sources (e.g., communication-based platforms, websites, calendars, email systems, databases, etc.), conventional techniques for identifying, accessing, and aggregating the content may be ineffective, inefficient, disruptive to the user experience, and/or lead to suboptimal results. For example, provided that a user is attempting to identify content that is relevant to a particular project, topic, event, etc., the user is unable to access all of this content in a single location, and is instead required to visit each of these different sources to identify and access the content. Furthermore, a user performing searches may not yield relevant content. Even if such content is identified in the different sources, the user then needs to aggregate the content and manually input the content into a single space/location. In some embodiments, the space/location may be a canvas virtual space configured to provide a means for curating, organizing, and sharing collections of information for a single user or between user profiles associated with a virtual space. That is, a canvas virtual space may include important and/or relevant information for a particular project, topic, event, etc. or the user profiles that are members of the virtual space. In some cases, when creating and/or updating the canvas virtual space, data may be posted or added to the canvas virtual space to ensure that the canvas virtual space includes the most relevant, timely, and updated information. However, in some cases, the data input to the canvas virtual space may be difficult to understand and/or in an incorrect (or suboptimal) format. Moreover, the data added to the canvas virtual space may not be relevant to the project, topic, event, etc. associated with the canvas virtual space.

In addition, end users, such as sales and service professionals have to pivot between multiple applications, websites, tabs, and other data sources (e.g., notes, presentations, etc.) to search for and identify the information they are looking for when handling a service call, or preparing for a meeting, for example. The users typically have to “swivel chair” between all of these data sources and manually synthesize the data from the multiple data sources in order to analyze and create action items, determine processes to perform, and so on. Such a process takes a significant amount of time and expends valuable computing resources needed to navigate and toggle between these different resources. Moreover, it is difficult to create custom dashboards with contextual data to help improve productivity for sales, service, marketers and other key user profiles. Users in sales, service, marketing etc. roles struggle to find contextual information from different sources (e.g., the entity in which they are employed, external documents, virtual spaces (e.g., channels) within group-based communication systems, internal documents, websites, etc.) to help achieve their goals, whether those goals relate to resolving a customer case, or advancing an opportunity to close a client, or to partnering with a client or potential client. Chat-based interfaces are commonly utilized to search for and identify data, but such chat-based interfaces are limited since they typically only provide specific answers to specific user questions in a text-based format. For instance, a broader context with respect to the user's question may be better served in a visual format, such as a user interface-like format so that the user can fully comprehend the results that are responsive to the initial query.

To address these and other technical problems and inefficiencies, techniques for identifying, aggregating, and presenting data within a virtual space (e.g., a canvas virtual space) utilizing one or more generative AI techniques are discussed herein. A generative AI-enabled system may intelligently retrieve data from various sources (both internal and external to the user or the organization of the user) and help answer questions/queries of the user or assist in solving a problem of the user in real-time and in a matter of seconds, as opposed to hours or days. Using recommended prompt suggestions, and/or by prompting the creation of a canvas virtual space, the systems and processes described herein may curate the best possible answers to a user's question, prompt, query, etc. into a dynamically created user interface that comprises tiles, components, sections, etc. of content related, and responsive, to the user's question(s)/query(ies). In particular, generative AI may be utilized to identify data relevant to user from a plurality of different resources (e.g., communication-based platforms, calendars, databases, websites, email systems/accounts, etc.), aggregate that data, and then generate a canvas virtual space (or a “generative AI canvas” virtual space) that includes such data. Within the canvas virtual space, the data may be organized, modified, rearranged, expanded, reduced, and so on based on preferences of the user, viewing preferences of that particular user based on previous actions/activity of that user, and/or viewing preferences of other users based on previous actions/activity of those other users. As a result, the user may access a single canvas virtual space to view relevant information about the user, relevant information about a project associated with the user, and so on.

Initially, the user may be presented with a user interface that allows the user to generate the canvas virtual space. The user may be prompted with suggested questions that may help the user generate the canvas virtual space. The user interface may also include a input field (e.g., text entry box) that allows the user to input text that is utilized to generate the canvas virtual space. Regardless of how the canvas virtual space is generated, the canvas virtual space may present/display various types of information that are relevant to the user, or a project, account, etc. that the user is working on. For instance, with respect to a particular project that the user is associated with, the canvas virtual space may include different tiles, sections, or partitions that include information relating to different aspects of the project, such as summary or overview of the project, upcoming deadlines, a listing of team members, a listing of other involved organizations/entities and associated key personnel, a current status of the project, a list of tasks to be performed by the user and/or other users, etc. As a result, with respect to this project, the user need only access the canvas virtual space to access aggregated and relevant information relating to the project, as opposed to the user having to spend the time and computational resources attempting to find such information from many different sources.

In some embodiments, the size, shape, configuration, layout, etc. of the different tiles/sections within the canvas virtual space may be modified based on preferences of the user, prior actions of the user with respect to the canvas virtual space, and/or prior actions of other users with respect to corresponding canvas virtual spaces. Moreover, the amount of information or content displayed within a section of the canvas virtual space may vary such that a robust amount of information may be displayed. On the other hand, a summary or condensed version of that same information may be displayed. The canvas virtual space may include user selectable controls that allows a user to select or modify the manner in which the different tiles/sections of the canvas virtual space, or the information contained therein, is displayed within the canvas virtual space. As discussed throughout this disclosure, the techniques may improve the user experience by enabling users to organize data or content in a manner that is easy to consume, process, and/or distribute.

For the purposes of this disclosure, the communication platform that hosts and/or maintains the canvas virtual space can be a group-based communication platform, a channel-based messaging platform, a sales-based platform, and/or any other platform for facilitating communication between and among users. Users can use a variety of devices (or “user devices”) to access the communication platform. Such devices may include any suitable type of computing device, e.g., portable, semi-portable, semi-stationary, or stationary. Some examples of a user device can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

### Group-Based Communication System

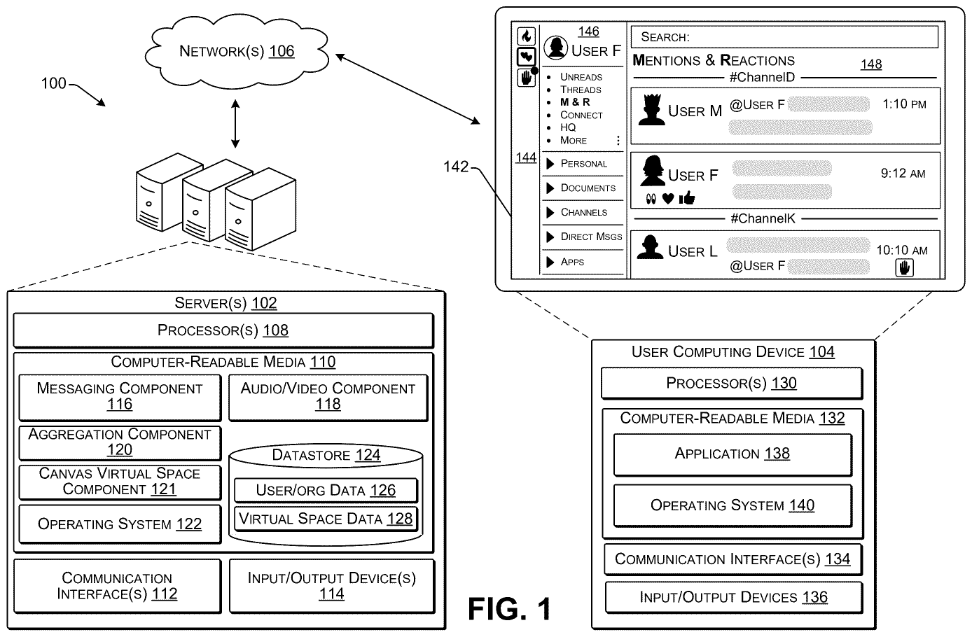

FIG. 1 illustrates an example environment 100 for performing techniques described herein. In at least one example, the example environment 100 can be associated with a communication platform that can leverage a network-based computing system to enable users of the communication platform to exchange data. In at least one example, the communication platform can be “group-based” such that the platform, and associated systems, communication channels, messages, collaborative documents, canvases, audio/video conversations, and/or other virtual spaces, have security (that can be defined by permissions) to limit access to a defined group of users. In some examples, such groups of users can be defined by group identifiers, as described above, which can be associated with common access credentials, domains, or the like. In some examples, the communication platform can be a hub, offering a secure and private virtual space to enable users to chat, meet, call, collaborate, transfer files or other data, or otherwise communicate between or among each other. As described above, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the example environment 100 can include one or more server computing devices (or “server(s)”) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device, e.g., portable, semi-portable, semi-stationary, or stationary. Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example environment 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, and/or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processors 108, computer-readable media 110, one or more communication interfaces 112, and/or input/output devices 114.

In at least one example, each processor of the processor(s) 108 can be a single processing unit or multiple processing units, and can include single or multiple computing units or multiple processing cores. The processor(s) 108 can be implemented as one or more microprocessors, microcomputers, microcontrollers, digital signal processors, central processing units (CPUs), graphics processing units (GPUs), tensor processing units (TPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media can optionally include a messaging component 116, an audio/video component 118, an aggregation component 120, a canvas virtual space component 121, an operating system 122, and a datastore 124.

In at least one example, the messaging component 116 can process messages between users. That is, in at least one example, the messaging component 116 can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. Additionally, the messages can be transmitted in association with a collaborative document, canvas, or other collaborative space. In at least one example, the canvas can include a flexible canvas for curating, organizing, and sharing collections of information for a particular user and/or between multiple users. In at least one example, the collaborative document can be associated with a document identifier (e.g., virtual space identifier, communication channel identifier, etc.) configured to enable messaging functionalities attributable to a virtual space (e.g., a communication channel) within the collaborative document. That is, the collaborative document can be treated as, and include the functionalities associated with, a virtual space, such as a communication channel. The virtual space, or communication channel, can be a data route used for exchanging data between and among systems and devices associated with the communication platform.

In at least one example, the messaging component 116 can establish a communication route between and among various user computing devices, allowing the user computing devices to communicate and share data between and among each other. In at least one example, the messaging component 116 can manage such communications and/or sharing of data. In some examples, data associated with a virtual space, such a collaborative document, can be presented via a user interface. In addition, metadata associated with each message transmitted via the virtual space, such as a timestamp associated with the message, a sending user identifier, a recipient user identifier, a conversation identifier and/or a root object identifier (e.g., conversation associated with a thread and/or a root object), and/or the like, can be stored in association with the virtual space.

In various examples, the messaging component 116 can receive a message transmitted in association with a virtual space (e.g., direct message instance, communication channel, canvas, collaborative document, etc.). In various examples, the messaging component 116 can identify one or more users associated with the virtual space and can cause a rendering of the message in association with instances of the virtual space on respective user computing devices 104. In various examples, the messaging component 116 can identify the message as an update to the virtual space and, based on the identified update, can cause a notification associated with the update to be presented in association with a sidebar of user interface associated with one or more of the user(s) associated with the virtual space. For example, the messaging component 116 can receive, from a first user account, a message transmitted in association with a virtual space. In response to receiving the message (e.g., interaction data associated with an interaction of a first user with the virtual space), the messaging component 116 can identify a second user associated with the virtual space (e.g., another user that is a member of the virtual space). In some examples, the messaging component 116 can cause a notification of an update to the virtual space to be presented via a sidebar of a user interface associated with a second user account of the second user. In some examples, the messaging component 116 can cause the notification to be presented in response to a determination that the sidebar of the user interface associated with the second user account includes an affordance associated with the virtual space. In such examples, the notification can be presented in association with the affordance associated with the virtual space.

In various examples, the messaging component 116 can be configured to identify a mention or tag associated with the message transmitted in association with the virtual space. In at least one example, the mention or tag can include an @mention (or other special character) of a user identifier that is associated with the communication platform. The user identifier can include a username, real name, or other unique identifier that is associated with a particular user. In response to identifying the mention or tag of the user identifier, the messaging component 116 can cause a notification to be presented on a user interface associated with the user identifier, such as in association with an affordance associated with the virtual space in a sidebar of a user interface associated with the particular user and/or in a virtual space associated with mentions and reactions. That is, the messaging component 116 can be configured to alert a particular user that they were mentioned in a virtual space.

In at least one example, the audio/video component 118 can be configured to manage audio and/or video communications between and among users. In some examples, the audio and/or video communications can be associated with an audio and/or video conversation. In at least one example, the audio and/or video conversation can include a discrete identifier configured to uniquely identify the audio and/or video conversation. In some examples, the audio and/or video component 118 can store user identifiers associated with user accounts of members of a particular audio and/or video conversation, such as to identify user(s) with appropriate permissions to access the particular audio and/or video conversation.

In some examples, communications associated with an audio and/or video conversation (“conversation”) can be synchronous and/or asynchronous. That is, the conversation can include a real-time audio and/or video conversation between a first user and a second user during a period of time and, after the first period of time, a third user who is associated with (e.g., is a member of) the conversation can contribute to the conversation. The audio/video component 118 can be configured to store audio and/or video data associated with the conversation, such as to enable users with appropriate permissions to listen and/or view the audio and/or video data.

In some examples, the audio/video component 118 can be configured to generate a transcript of the conversation, and can store the transcript in association with the audio and/or video data. The transcript can include a textual representation of the audio and/or video data. In at least one example, the audio/video component 118 can use known speech recognition techniques to generate the transcript. In some examples, the audio/video component 118 can generate the transcript concurrently or substantially concurrently with the conversation. That is, in some examples, the audio/video component 118 can be configured to generate a textual representation of the conversation while it is being conducted. In some examples, the audio/video component 118 can generate the transcript after receiving an indication that the conversation is complete. The indication that the conversation is complete can include an indication that a host or administrator associated therewith has stopped the conversation, that a threshold number of meeting attendees have closed associated interfaces, and/or the like. That is, the audio/video component 118 can identify a completion of the conversation and, based on the completion, can generate the transcript associated therewith.

In at least one example, the audio/video component 118 can be configured to cause presentation of the transcript in association with a virtual space with which the audio and/or video conversation is associated. For example, a first user can initiate an audio and/or video conversation in association with a communication channel. The audio/video component 118 can process audio and/or video data between attendees of the audio and/or video conversation, and can generate a transcript of the audio and/or video data. In response to generating the transcript, the audio/video component 118 can cause the transcript to be published or otherwise presented via the communication channel. In at least one example, the audio/video component 118 can render one or more sections of the transcript selectable for commenting, such as to enable members of the communication channel to comment on, or further contribute to, the conversation. In some examples, the audio/video component 118 can update the transcript based on the comments.

In at least one example, the audio/video component 118 can manage one or more audio and/or video conversations in association with a virtual space associated with a group (e.g., organization, team, etc.) administrative or command center. The group administrative or command center can be referred to herein as a virtual (and/or digital) headquarters associated with the group. In at least one example, the audio/video component 118 can be configured to coordinate with the messaging component 116 and/or other components of the server(s) 102, to transmit communications in association with other virtual spaces that are associated with the virtual headquarters. That is, the messaging component 116 can transmit data (e.g., messages, images, drawings, files, etc.) associated with one or more communication channels, direct messaging instances, collaborative documents, canvases, and/or the like, that are associated with the virtual headquarters. In some examples, the communication channel(s), direct messaging instance(s), collaborative document(s), canvas(es), and/or the like can have associated therewith one or more audio and/or video conversations managed by the audio/video component 118. That is, the audio and/or video conversations associated with the virtual headquarters can be further associated with, or independent of, one or more other virtual spaces of the virtual headquarters.

In at least some examples, the aggregation component 120 may identify, based on a topic, project, event, etc. associated with a canvas virtual space, content relevant to the canvas virtual space that resides in, or is maintained by, multiple different sources. The aggregation component 120 may also aggregate the relevant content and populate the canvas virtual space with such relevant content. For instance, with respect to a project relating to a potential business partner or client, the aggregation component 120 may identify information or data relevant to the project in various sources, such as virtual spaces of a communication platform, websites, electronic calendars, email systems, databases, etc. The aggregation component may collect and aggregate the data for input into the canvas virtual space.

In at least some examples, the canvas virtual space component 121 may input the relevant content identified by the aggregation component 120 into the canvas virtual space. Different portions of the relevant content may be included in different sections or partitions of the canvas virtual space. For instance, using the example referenced in the preceding paragraph, first content related to upcoming deadlines for the project may be included in a first section, second content related to the specific potential business partner/content may be included in a second section, third content related to a timeline of previous discussions may be included in a third section, fourth content related to financial information/goals may be included in a fourth section, and so on. That way, the canvas virtual space may include different types of relevant information that are related to the content associated with the canvas virtual space. Moreover, the content presented within the canvas virtual space may be arranged in different manners, and may be modified based on preferences of the user or other users.

In some examples, the communication platform can manage communication channels. In some examples, the communication platform can be a channel-based messaging platform, that in some examples, can be usable by group(s) of users. Users of the communication platform can communicate with other users via communication channels. A communication channel, or virtual space, can be a data route used for exchanging data between and among systems and devices associated with the communication platform. In some examples, a channel can be a virtual space where people can post messages, documents, and/or files. In some examples, access to channels can be controlled by permissions. In some examples, channels can be limited to a single organization, shared between different organizations, public, private, or special channels (e.g., hosted channels with guest accounts where guests can make posts but are prevented from performing certain actions, such as inviting other users to the channel). In some examples, some users can be invited to channels via email, channel invites, direct messages, text messages, and the like. Examples of channels and associated functionality are discussed throughout this disclosure.

In at least one example, the operating system 122 can manage the processor(s) 108, computer-readable media 110, hardware, software, etc. of the server(s) 102.

In at least one example, the datastore 124 can be configured to store data that is accessible, manageable, and updatable. In some examples, the datastore 124 can be integrated with the server(s) 102, as shown in FIG. 1. In other examples, the datastore 124 can be located remotely from the server(s) 102 and can be accessible to the server(s) 102 and/or user device(s), such as the user device 104. The datastore 124 can comprise multiple databases, which can include user/org data 126 and/or virtual space data 128. Additional or alternative data may be stored in the data store and/or one or more other data stores.

In at least one example, the user/org data 126 can include data associated with users of the communication platform. In at least one example, the user/org data 126 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In at least one example, the user/org data 126 can include permission data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. Permissions associated with an individual user can be mapped to, or otherwise associated with, an account or profile within the user/org data 126. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In at least one example, the user/org data 126 can include data associated with one or more organizations of the communication platform. In at least one example, the user/org data 126 can store data in organization profiles, which can store data associated with an organization, including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

In at least one example, the virtual space data 128 can include data associated with one or more virtual spaces associated with the communication platform. The virtual space data 128 can include textual data, audio data, video data, images, files, and/or any other type of data configured to be transmitted in association with a virtual space. Non-limiting examples of virtual spaces include workspaces, communication channels, direct messaging instances, collaborative documents, canvases, and audio and/or video conversations. In at least one example, the virtual space data can store data associated with individual virtual spaces separately, such as based on a discrete identifier associated with each virtual space. In some examples, a first virtual space can be associated with a second virtual space. In such examples, first virtual space data associated with the first virtual space can be stored in association with the second virtual space. For example, data associated with a collaborative document that is generated in association with a communication channel may be stored in association with the communication channel. For another example, data associated with an audio and/or video conversation that is conducted in association with a communication channel can be stored in association with the communication channel.

As discussed above, each virtual space of the communication platform can be assigned a discrete identifier that uniquely identifies the virtual space. In some examples, the virtual space identifier associated with the virtual space can include a physical address in the virtual space data 128 where data related to that virtual space is stored. A virtual space may be “public,” which may allow any user within an organization (e.g., associated with an organization identifier) to join and participate in the data sharing through the virtual space, or a virtual space may be “private,” which may restrict data communications in the virtual space to certain users or users having appropriate permissions to view. In some examples, a virtual space may be “shared,” which may allow users associated with different organizations (e.g., entities associated with different organization identifiers) to join and participate in the data sharing through the virtual space. Shared virtual spaces (e.g., shared channels) may be public such that they are accessible to any user of either organization, or they may be private such that they are restricted to access by certain users (e.g., users with appropriate permissions) of both organizations.

In some examples, the datastore 124 can be partitioned into discrete items of data that may be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 124 that stores data related to a particular organization identification. For example, a database shard may store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared virtual space).

In some examples, individual groups can be associated with a database shard within the datastore 124 that stores data related to a particular group identification (e.g., workspace). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a virtual space can be associated with a database shard within the datastore 124 that stores data related to a particular virtual space identification. For example, a database shard may store electronic communication data associated with the virtual space, which enables members of that particular virtual space to communicate and exchange data with other members of the same virtual space in real time or near-real time. As discussed above, the communications via the virtual space can be synchronous and/or asynchronous. In at least one example, a group or organization can be the owner of the database shard and can control where and how the related data is stored.

In some examples, individual users can be associated with a database shard within the datastore 124 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

In some examples, such as when a channel is shared between two organizations, each organization can be associated with its own encryption key. When a user associated with one organization posts a message or file to the shared channel it can be encrypted in the datastore 124 with the encryption key specific to the organization and the other organization can decrypt the message or file prior to accessing the message or file. Further, in examples where organizations are in different geographical areas, data associated with a particular organization can be stored in a location corresponding to the organization and temporarily cached at a location closer to a client (e.g., associated with the other organization) when such messages or files are to be accessed. Data can be maintained, stored, and/or deleted in the datastore 124 in accordance with a data governance policy associated with each specific organization.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via WebSockets, Application Programming Interfaces (APIs) (e.g., using API calls), Hypertext Transfer Protocols (HTTPs), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 130, computer-readable media 132, one or more communication interfaces 134, and input/output devices 136.

In at least one example, each processor of the processor(s) 130 can be a single processing unit or multiple processing units, and can include single or multiple computing units or multiple processing cores. The processor(s) 130 can comprise any of the types of processors described above with reference to the processor(s) 108 and may be the same as or different than the processor(s) 108.

The computer-readable media 132 can comprise any of the types of computer-readable media 132 described above with reference to the computer-readable media 110 and may be the same as or different than the computer-readable media 110. Functional components stored in the computer-readable media can optionally include at least one application 138 and an operating system 140.

In at least one example, the application 138 can be a mobile application, a web application, or a desktop application, which can be provided by the communication platform or which can be an otherwise dedicated application. In some examples, individual user computing devices associated with the environment 100 can have an instance or versioned instance of the application 138, which can be downloaded from an application store, accessible via the Internet, or otherwise executable by the processor(s) 130 to perform operations as described herein. That is, the application 138 can be an access point, enabling the user computing device 104 to interact with the server(s) 102 to access and/or use communication services available via the communication platform. In at least one example, the application 138 can facilitate the exchange of data between and among various other user computing devices, for example via the server(s) 102. In at least one example, the application 138 can present user interfaces, as described herein. In at least one example, a user can interact with the user interfaces via touch input, keyboard input, mouse input, spoken input, or any other type of input.

A non-limiting example of a user interface 142 is shown in FIG. 1. As illustrated in FIG. 1, the user interface 142 can present data associated with one or more virtual spaces, which may include one or more workspaces. That is, in some examples, the user interface 142 can integrate data from multiple workspaces into a single user interface so that the user (e.g., of the user computing device 104) can access and/or interact with data associated with the multiple workspaces that he or she is associated with and/or otherwise communicate with other users associated with the multiple workspaces. In some examples, the user interface 142 can include a first region 144, or pane, that includes indicator(s) (e.g., user interface element(s) or object(s)) associated with workspace(s) with which the user (e.g., account of the user) is associated. In some examples, the user interface 142 can include a second region 146, or pane, that includes indicator(s) (e.g., user interface element(s), affordance(s), object(s), etc.) representing data associated with the workspace(s) with which the user (e.g., account of the user) is associated. In at least one example, the second region 146 can represent a sidebar of the user interface 142.

In at least one example, the user interface 142 can include a third region 148, or pane, that can be associated with a data feed (or, “feed”) indicating messages posted to and/or actions taken with respect to one or more communication channels and/or other virtual spaces for facilitating communications (e.g., a virtual space associated with direct message communication(s), a virtual space associated with event(s) and/or action(s), etc.) as described herein. In at least one example, data associated with the third region 148 can be associated with the same or different workspaces. That is, in some examples, the third region 148 can present data associated with the same or different workspaces via an integrated feed. In some examples, the data can be organized and/or is sortable by workspace, time (e.g., when associated data is posted or an associated operation is otherwise performed), type of action, communication channel, user, or the like. In some examples, such data can be associated with an indication of which user (e.g., member of the communication channel) posted the message and/or performed an action. In examples where the third region 148 presents data associated with multiple workspaces, at least some data can be associated with an indication of which workspace the data is associated with. In some examples, the third region 148 may be resized or popped out as a standalone window.

In at least one example, the operating system 140 can manage the processor(s) 130, computer-readable media 132, hardware, software, etc. of the server(s) 102.

The communication interface(s) 134 can include one or more interfaces and hardware components for enabling communication with various other devices (e.g., the user computing device 104), such as over the network(s) 106 or directly. In some examples, the communication interface(s) 134 can facilitate communication via WebSockets, APIs (e.g., using API calls), HTTPs, etc.

The user computing device 104 can further be equipped with various input/output devices 136 (e.g., I/O devices). Such I/O devices 136 can include a display, various user interface controls (e.g., buttons, joystick, keyboard, mouse, touch screen, etc.), audio speakers, connection ports and so forth.

While techniques described herein are described as being performed by the messaging component 116, the audio/video component 118, and the application 138, techniques described herein can be performed by any other component, or combination of components, which can be associated with the server(s) 102, the user computing device 104, or a combination thereof.

### User Interface for a Group-Based Communication System

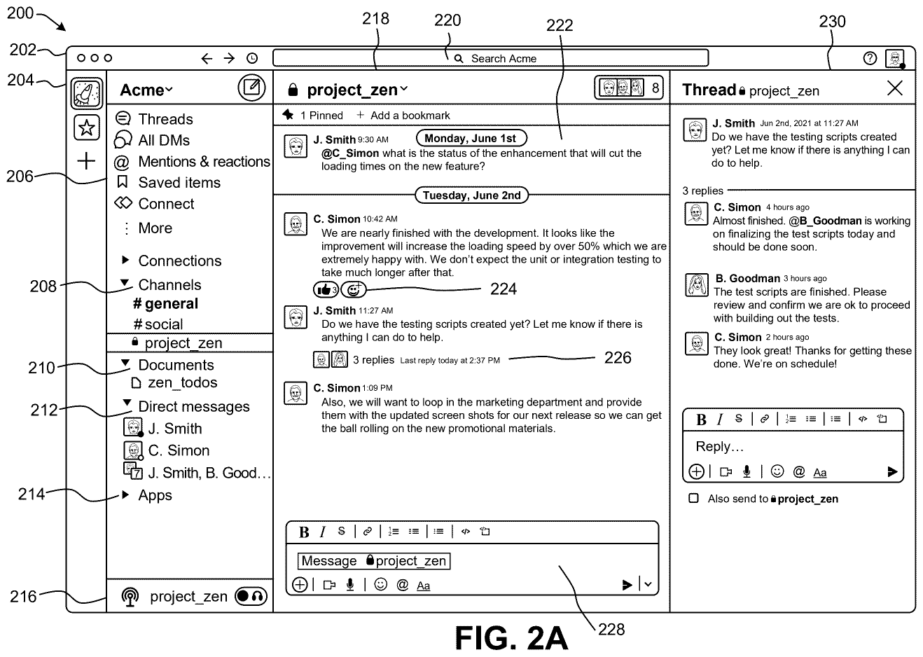

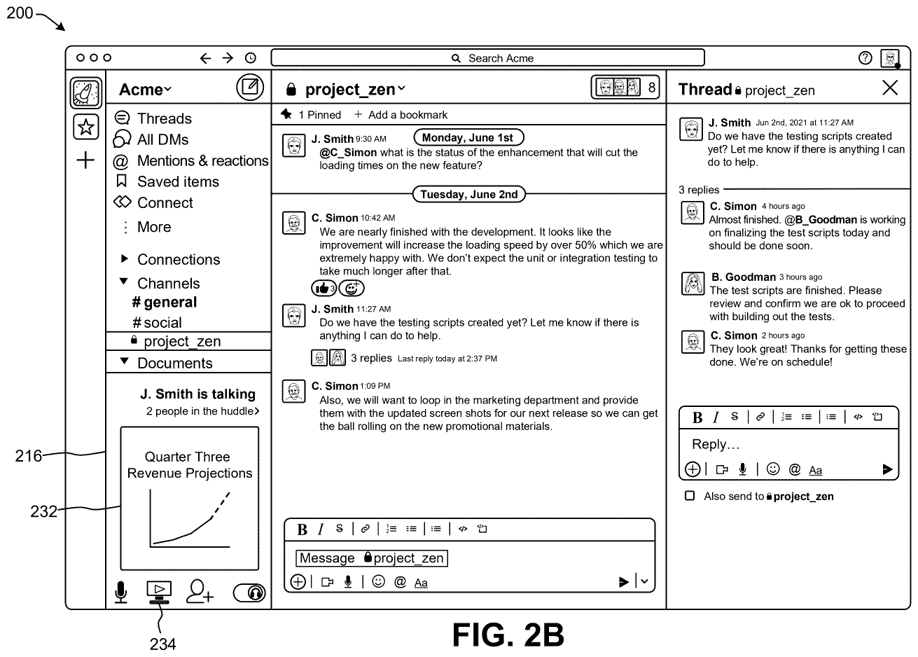

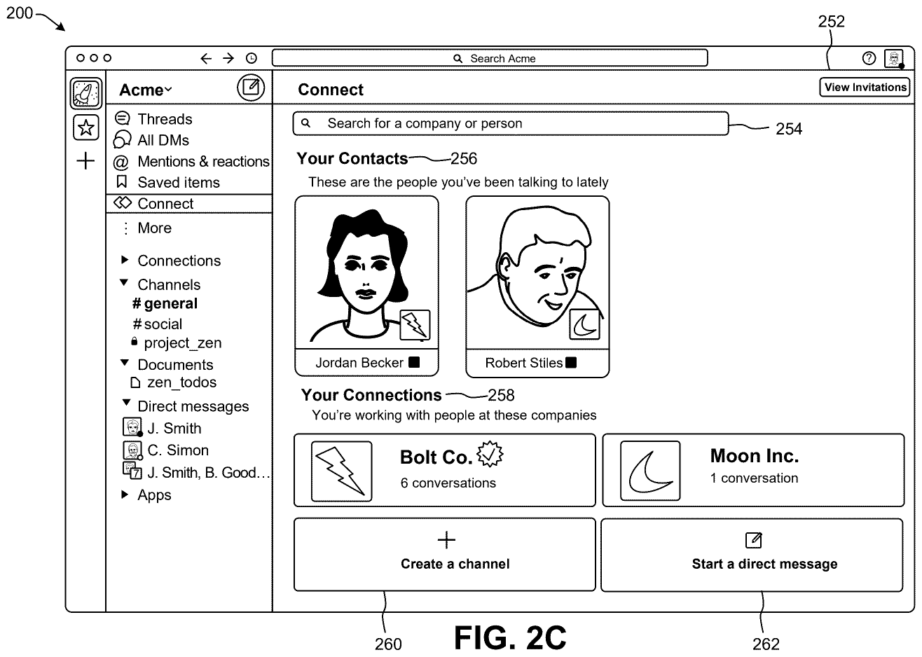

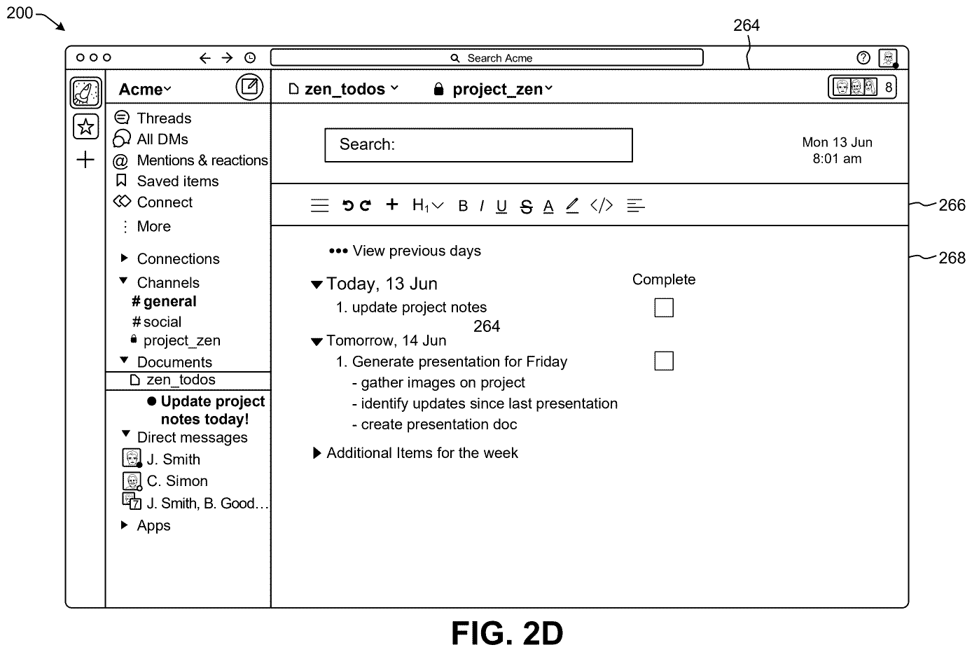

FIG. 2A illustrates a user interface 200 of a group-based communication system, which will be useful in illustrating the operation of various examples discussed herein. The group-based communication system may include communication data such as messages, queries, files, mentions, users or user profiles, interactions, tickets, channels, applications integrated into one or more channels, conversations, workspaces, or other data generated by or shared between users of the group-based communication system. In some instances, the communication data may comprise data associated with a user, such as a user identifier, channels to which the user has been granted access, groups with which the user is associated, permissions, and other user-specific information.

The user interface 200 comprises a plurality of objects such as panes, text entry fields, buttons, messages, or other user interface components that are viewable by a user of the group-based communication system. As depicted, the user interface 200 comprises a title bar 202, a workspace pane 204, a navigation pane 206, channels 208, documents 210 (e.g., collaborative documents), direct messages 212, applications 214, a synchronous multimedia collaboration session pane 216, and channel pane 218.

By way of example and without limitation, when a user opens the user interface 200 they can select a workspace via the workspace pane 204. A particular workspace may be associated with data specific to the workspace and accessible via permissions associated with the workspace. Different sections of the navigation pane 206 can present different data and/or options to a user. Different graphical indicators may be associated with virtual spaces (e.g., channels) to summarize an attribute of the channel (e.g., whether the channel is public, private, shared between organizations, locked, etc.). When a user selects a channel, a channel pane 218 may be presented. In some examples, the channel pane 218 can include a header, pinned items (e.g., documents or other virtual spaces), an “about” document providing an overview of the channel, and the like. In some cases, members of a channel can search within the channel, access content associated with the channel, add other members, post content, and the like. In some examples, depending on the permissions associated with a channel, users who are not members of the channel may have limited ability to interact with (or even view or otherwise access) a channel. As users navigate within a channel they can view messages 222 and may react to messages (e.g., a reaction 224), reply in a thread, start threads, and the like. Further, a channel pane 218 can include a compose pane 228 to compose message(s) and/or other data to associate with a channel. In some examples, the user interface 200 can include a threads pane 230 that provides additional levels of detail of the messages 222. In some examples, different panes can be resized, panes can be popped out to independent windows, and/or independent windows can be merged to multiple panes of the user interface 200. In some examples, users may communicate with other users via a collaboration pane 216, which may provide synchronous or asynchronous voice and/or video capabilities for communication. Of course, these are illustrative examples and additional examples of the aforementioned features are provided throughout this disclosure.

In some examples, title bar 202 comprises search bar 220. The search bar 220 may allow users to search for content located in the current workspace of the group-based communication system, such as files, messages, channels, members, commands, functions, and the like. Users may refine their searches by attributes such as content type, content author, and by users associated with the content. Users may optionally search within specific workspaces, channels, direct message conversations, or documents. In some examples, the title bar 202 comprises navigation commands allowing a user to move backwards and forwards between different panes, as well as to view a history of accessed content. In some examples, the title bar 202 may comprise additional resources such as links to help documents and user configuration settings.

In some examples, the group-based communication system can comprise a plurality of distinct workspaces, where each workspace is associated with different groups of users and channels. Each workspace can be associated with a group identifier and one or more user identifiers can be mapped to, or otherwise associated with, the group identifier. Users corresponding to such user identifiers may be referred to as members of the group. In some examples, the user interface 200 comprises the workspace pane 204 for navigating between, adding, or deleting various workspaces in the group-based communication system. For example, a user may be a part of a workspace for Acme, where the user is an employee of or otherwise affiliated with Acme. The user may also be a member of a local volunteer organization that also uses the group-based communication system to collaborate. To navigate between the two groups, the user may use the workspace pane 204 to change from the Acme workspace to the volunteer organization workspace. A workspace may comprise one or more channels that are unique to that workspace and/or one or more channels that are shared between one or more workspaces. For example, the Acme company may have a workspace for Acme projects, such as Project Zen, a workspace for social discussions, and an additional workspace for general company matters. In some examples, an organization, such as a particular company, may have a plurality of workspaces, and the user may be associated with one or more workspaces belonging to the organization. In yet other examples, a particular workspace can be associated with one or more organizations or other entities associated with the group-based communication system.

In some examples, the navigation pane 206 permits users to navigate between virtual spaces such as pages, channels 208, collaborative documents 210 (such as those discussed at FIG. 2D), applications 214, and direct messages 212 within the group-based communication system. For example, the navigation pane 206 can include indicators representing virtual spaces that can aggregate data associated with a plurality of virtual spaces of which the user is a member. In at least one example, each virtual space can be associated with an indicator in the navigation pane 206. In some examples, an indicator can be associated with an actuation mechanism (e.g., an affordance, also referred to as a graphical element) such that when actuated, can cause the user interface 200 to present data associated with the corresponding virtual space. In at least one example, a virtual space can be associated with all unread data associated with each of the workspaces with which the user is associated. That is, in some examples, if the user requests to access the virtual space associated with “unreads,” all data that has not been read (e.g., viewed) by the user can be presented, for example in a feed. In such examples, different types of events and/or actions, which can be associated with different virtual spaces, can be presented via the same feed. In some examples, such data can be organized and/or is sortable by associated virtual space (e.g., virtual space via which the communication was transmitted), time, type of action, user, and/or the like. In some examples, such data can be associated with an indication of which user (e.g., member of the associated virtual space) posted the message and/or performed an action.

In some examples, a virtual space can be associated with the same type of event and/or action. For example, “threads” can be associated with messages, files, etc. posted in threads to messages posted in a virtual space and “mentions and reactions” can be associated with messages or threads where the user has been mentioned (e.g., via a tag) or another user has reacted (e.g., via an emoji, reaction, or the like) to a message or thread posted by the user. That is, in some examples, the same types of events and/or actions, which can be associated with different virtual spaces, can be presented via the same feed. As with the “unreads” virtual space, data associated with such virtual spaces can be organized and/or is sortable by virtual space, time, type of action, user, and/or the like.

In some examples, a virtual space can be associated with facilitating communications between a user and other users of the communication platform. For example, “connect” can be associated with enabling the user to generate invitations to communicate with one or more other users. In at least one example, responsive to receiving an indication of selection of the “connect” indicator, the communication platform can cause a connections interface to be presented.

In some examples, a virtual space can be associated with one or more boards or collaborative documents with which the user is associated. In at least one example, a document can include a collaborative document configured to be accessed and/or edited by two or more users with appropriate permissions (e.g., viewing permissions, editing permissions, etc.). In at least one example, if the user requests to access the virtual space associated with one or more documents with which the user is associated, the one or more documents can be presented via the user interface 200. In at least one example, the documents, as described herein, can be associated with an individual (e.g., private document for a user), a group of users (e.g., collaborative document), and/or one or more communication channels (e.g., members of the communication channel rendered access permissions to the document), such as to enable users of the communication platform to create, interact with, and/or view data associated with such documents. In some examples, the collaborative document can be a virtual space, a board, a canvas, a page, or the like for collaborative communication and/or data organization within the communication platform. In at least one example, the collaborative document can support editable text and/or objects that can be ordered, added, deleted, modified, and/or the like. In some examples, the collaborative document can be associated with permissions defining which users of a communication platform can view and/or edit the document. In some examples, a collaborative document can be associated with a communication channel, and members of the communication channel can view and/or edit the document. In some examples, a collaborative document can be sharable such that data associated with the document is accessible to and/or interactable for members of the multiple communication channels, workspaces, organizations, and/or the like.

In some examples, a virtual space can be associated with a group (e.g., organization, team, etc.) headquarters (e.g., administrative or command center). In at least one example, the group headquarters can include a virtual or digital headquarters for administrative or command functions associated with a group of users. For example, “HQ” can be associated with an interface including a list of indicators associated with virtual spaces configured to enable associated members to communicate. In at least one example, the user can associate one or more virtual spaces with the “HQ” virtual space, such as via a drag and drop operation. That is, the user can determine relevant virtual space(s) to associate with the virtual or digital headquarters, such as to associate virtual space(s) that are important to the user therewith.

In some examples, a virtual space can be associated with one or more boards or collaborative documents with which the user is associated. In at least one example, a document can include a collaborative document configured to be accessed and/or edited by two or more users with appropriate permissions (e.g., viewing permissions, editing permissions, etc.). In at least one example, if the user requests to access the virtual space associated with one or more documents with which the user is associated, the one or more documents can be presented via the user interface 200. In at least one example, the documents, as described herein, can be associated with an individual (e.g., private document for a user), a group of users (e.g., collaborative document), and/or one or more communication channels (e.g., members of the communication channel rendered access permissions to the document), such as to enable users of the communication platform to create, interact with, and/or view data associated with such documents. In some examples, the collaborative document can be a virtual space, a board, a canvas, a page, or the like for collaborative communication and/or data organization within the communication platform. In at least one example, the collaborative document can support editable text and/or objects that can be ordered, added, deleted, modified, and/or the like. In some examples, the collaborative document can be associated with permissions defining which users of a communication platform can view and/or edit the document. In some examples, a collaborative document can be associated with a communication channel, and members of the communication channel can view and/or edit the document. In some examples, a collaborative document can be sharable such that data associated with the document is accessible to and/or interactable for members of the multiple communication channels, workspaces, organizations, and/or the like.

Additionally or in the alternative, in some examples, a virtual space can be associated with one or more canvases with which the user is associated. In at least one example, the canvas can include a flexible canvas for curating, organizing, and sharing collections of information between users. That is, the canvas can be configured to be accessed and/or modified by two or more users with appropriate permissions. In at least one example, the canvas can be configured to enable sharing of text, images, videos, GIFs, drawings (e.g., user-generated drawing via a canvas interface), gaming content (e.g., users manipulating gaming controls synchronously or asynchronously), and/or the like. In at least one example, modifications to a canvas can include adding, deleting, and/or modifying previously shared (e.g., transmitted, presented) data. In some examples, content associated with a canvas can be shareable via another virtual space, such that data associated with the canvas is accessible to and/or rendered interactable for members of the virtual space.

The navigation pane 206 may further comprise indicators representing communication channels (e.g., the channels 208). In some examples, the communication channels can include public channels, private channels, shared channels (e.g., between groups or organizations), single workspace channels, cross-workspace channels, combinations of the foregoing, or the like. In some examples, the communication channels represented can be associated with a single workspace. In some examples, the communication channels represented can be associated with different workspaces (e.g., cross-workspace). In at least one example, if a communication channel is cross-workspace (e.g., associated with different workspaces), the user may be associated with both workspaces, or may only be associated with one of the workspaces. In some examples, the communication channels represented can be associated with combinations of communication channels associated with a single workspace and communication channels associated with different workspaces.

In some examples, the navigation pane 206 may depict some or all of the communication channels that the user has permission to access (e.g., as determined by the permission data). In such examples, the communication channels can be arranged alphabetically, based on most recent interaction, based on frequency of interactions, based on communication channel type (e.g., public, private, shared, cross-workspace, etc.), based on workspace, in user-designated sections, or the like. In some examples, the navigation pane 206 can depict some or all of the communication channels that the user is a member of, and the user can interact with the user interface 200 to browse or view other communication channels that the user is not a member of but are not currently displayed in the navigation pane 206. In some examples, different types of communication channels (e.g., public, private, shared, cross-workspace, etc.) can be in different sections of the navigation pane 206, or can have their own sub-regions or sub-panes in the user interface 200. In some examples, communication channels associated with different workspaces can be in different sections of the navigation pane 206, or can have their own regions or panes in the user interface 200.

In some examples, the indicators can be associated with graphical elements that visually differentiate types of communication channels. For example, project_zen is associated with a lock graphical element. As a non-limiting example, and for the purpose of this discussion, the lock graphical element can indicate that the associated communication channel, project_zen, is private and access thereto is limited, whereas another communication channel, general, is public and access thereto is available to any member of an organization with which the user is associated. In some examples, additional or alternative graphical elements can be used to differentiate between shared communication channels, communication channels associated with different workspaces, communication channels with which the user is or is not a current member, and/or the like.

In at least one example, the navigation pane 206 can include indicators representative of communications with individual users or multiple specified users (e.g., instead of all, or a subset of, members of an organization). Such communications can be referred to as “direct messages.” The navigation pane 206 can include indicators representative of virtual spaces that are associated with private messages between one or more users.

The direct messages 212 may be communications between a first user and a second user, or they may be multi-person direct messages between a first user and two or more second users. The navigation pane 206 may be sorted and organized into hierarchies or sections depending on the user's preferences. In some examples, all of the channels to which a user has been granted access may appear in the navigation pane 206. In other examples, the user may choose to hide certain channels or collapse sections containing certain channels. Items in the navigation pane 206 may indicate when a new message or update has been received or is currently unread, such as by bolding the text associated with a channel in which an unread message is located or adding an icon or badge (for example, with a count of unread messages) to the channel name. In some examples, the group-based communication system may additionally or alternatively store permissions data associated with permissions of individual users of the group-based communication system, indicating which channels a user may view or join. Permissions can indicate, for example, which users can communicate directly with other users, which channels a user is permitted to access, restrictions on individual channels, which workspaces the user is permitted to access, and restrictions on individual workspaces.

Additionally or in the alternative, the navigation pane 206 can include a sub-section that is a personalized sub-section associated with a team of which the user is a member. That is, the “team” sub-section can include affordance(s) of one or more virtual spaces that are associated with the team, such as communication channels, collaborative documents, direct messaging instances, audio or video synchronous or asynchronous meetings, and/or the like. In at least one example, the user can associate selected virtual spaces with the team sub-section, such as by dragging and dropping, pinning, or otherwise associating selected virtual spaces with the team sub-section.

### Channels Within the Group-Based Communication System

In some examples, the group-based communication system is a channel-based messaging platform, as shown in FIG. 2A. Within the group-based communication system, communication may be organized into channels, each dedicated to a particular topic and a set of users. Channels are generally a virtual space relating to a particular topic comprising messages and files posted by members of the channel.

For purposes of this discussion, a “message” can refer to any electronically generated digital object provided by a user using the user computing device 104 and that is configured for display within a communication channel and/or other virtual space for facilitating communications (e.g., a virtual space associated with direct message communication(s), etc.) as described herein. A message may include any text, image, video, audio, or combination thereof provided by a user (using a user computing device). For instance, the user may provide a message that includes text, as well as an image and a video, within the message as message contents. In such an example, the text, image, and video would comprise the message. Each message sent or posted to a communication channel of the communication platform can include metadata comprising a sending user identifier, a message identifier, message contents, a group identifier, a communication channel identifier, or the like. In at least one example, each of the foregoing identifiers may comprise American Standard Code for Information Interchange (ASCII) text, a pointer, a memory address, or the like.

The channel discussion may persist for days, months, or years and provide a historical log of user activity. Members of a particular channel can post messages within that channel that are visible to other members of that channel together with other messages in that channel. Users may select a channel for viewing to see only those messages relevant to the topic of that channel without seeing messages posted in other channels on different topics. For example, a software development company may have different channels for each software product being developed, where developers working on each particular project can converse on a generally singular topic (e.g., project) without noise from unrelated topics. Because the channels are generally persistent and directed to a particular topic or group, users can quickly and easily refer to previous communications for reference. In some examples, the channel pane 218 may display information related to a channel that a user has selected in the navigation pane 206. For example, a user may select the project_zen channel to discuss the ongoing software development efforts for Project Zen. In some examples, the channel pane 218 may include a header comprising information about the channel, such as the channel name, the list of users in the channel, and other channel controls. Users may be able to pin items to the header for later access and add bookmarks to the header. In some examples, links to collaborative documents may be included in the header. In further examples, each channel may have a corresponding virtual space which includes channel-related information such as a channel summary, tasks, bookmarks, pinned documents, and other channel-related links which may be editable by members of the channel.

A communication channel or other virtual space can be associated with data and/or content other than messages, or data and/or content that is associated with messages. For example, non-limiting examples of additional data that can be presented via the channel pane 218 of the user interface 200 include collaborative documents (e.g., documents that can be edited collaboratively, in real-time or near real-time, etc.), audio and/or video data associated with a conversation, members added to and/or removed from the communication channel, file(s) (e.g., file attachment(s)) uploaded and/or removed from the communication channel), application(s) added to and/or removed from the communication channel, post(s) (data that can be edited collaboratively, in near real-time by one or members of a communication channel) added to and/or removed from the communication channel, description added to, modified, and/or removed from the communication channel, modifications of properties of the communication channel, etc.

The channel pane 218 may include messages such as message 222, which is content posted by a user into the channel. Users may post text, images, videos, audio, or any other file as the message 222. In some examples, particular identifiers (in messages or otherwise) may be denoted by prefixing them with predetermined characters. For example, channels may be prefixed by the “#” character (as in #project_zen) and username may be prefixed by the “@” character (as in @J_Smith or @User_A). Messages such as the message 222 may include an indication of which user posted the message and the time at which the message was posted. In some examples, users may react to messages by selecting a reaction button 224. The reaction button 224 allows users to select an icon (sometimes called a reacji in this context), such as a thumbs up, to be associated with the message. Users may respond to messages, such as the message 222, of another user with a new message. In some examples, such conversations in channels may further be broken out into threads. Threads may be used to aggregate messages related to a particular conversation together to make the conversation easier to follow and reply to, without cluttering the main channel with the discussion. Under the message beginning the thread appears a thread reply preview 226. The thread reply preview 226 may show information related to the thread, such as, for example, the number of replies and the members who have replied. Thread replies may appear in a thread pane 230 that may be separate from the channel pane 218 and may be viewed by other members of the channel by selecting the thread reply preview 226 in the channel pane 218.

In some examples, one or both of the channel pane 218 and the thread pane 230 may include a compose pane 228. In some examples, the compose pane 228 allows users to compose and transmit messages 222 to the members of the channel or to those members of the channel who are following the thread (when the message is sent in a thread). The compose pane 228 may have text editing functions such as bold, strikethrough, and italicize, and/or may allow users to format their messages or attach files such as collaborative documents, images, videos, or any other files to share with other members of the channel. In some examples, the compose pane 228 may enable additional formatting options such as numbered or bulleted lists via either the user interface or an API. The compose pane 228 may also function as a workflow trigger to initiate workflows related to a channel or message. In further examples, links or documents sent via the compose pane 228 may include unfurl instructions related to how the content should be displayed.

### Synchronous Multimedia Collaboration Sessions

FIG. 2B illustrates a multimedia collaboration session (e.g., a synchronous multimedia collaboration session) that has been triggered from a channel, as shown in pane 216. Synchronous multimedia collaboration sessions may provide ambient, ad hoc multimedia collaboration in the group-based communication system. Users of the group-based communication system can quickly and easily join and leave these synchronous multimedia collaboration sessions at any time, without disrupting the synchronous multimedia collaboration session for other users. In some examples, synchronous multimedia collaboration sessions may be based around a particular topic, a particular channel, a particular direct message or multi-person direct message, or a set of users, while in other examples, synchronous multimedia collaboration sessions may exist without being tied to any channel, topic, or set of users.

Synchronous multimedia collaboration session pane 216 may be associated with a session conducted for a plurality of users in a channel, users in a multi-person direct message conversation, or users in a direct message conversation. Thus, a synchronous multimedia collaboration session may be started for a particular channel, multi-person direct message conversation, or direct message conversation by one or more members of that channel or conversation. Users may start a synchronous multimedia collaboration session in a channel as a means of communicating with other members of that channel who are presently online. For example, a user may have an urgent decision and want immediate verbal feedback from other members of the channel. As another example, a synchronous multimedia collaboration session may be initiated with one or more other users of the group-based communication system through direct messaging. In some examples, the audience of a synchronous multimedia collaboration session may be determined based on the context in which the synchronous multimedia collaboration session was initiated. For example, starting a synchronous multimedia collaboration session in a channel may automatically invite the entire channel to attend. As another example. Starting a synchronous multimedia collaboration session allows the user to start an immediate audio and/or video conversation with other members of the channel without requiring scheduling or initiating a communication session through a third-party interface. In some examples, users may be directly invited to attend a synchronous multimedia collaboration session via a message or notification.

Synchronous multimedia collaboration sessions may be short, ephemeral sessions from which no data is persisted. Alternatively, in some examples, synchronous multimedia collaboration sessions may be recorded, transcribed, and/or summarized for later review. In other examples, contents of the synchronous multimedia collaboration session may automatically be persisted in a channel associated with the synchronous multimedia collaboration session. Members of a particular synchronous multimedia collaboration session can post messages within a messaging thread associated with that synchronous multimedia collaboration session that are visible to other members of that synchronous multimedia collaboration session together with other messages in that thread.

The multimedia in a synchronous multimedia collaboration session may include collaboration tools such as any or all of audio, video, screen sharing, collaborative document editing, whiteboarding, co-programming, or any other form of media. Synchronous multimedia collaboration sessions may also permit a user to share the user's screen with other members of the synchronous multimedia collaboration session. In some examples, members of the synchronous multimedia collaboration session may mark-up, comment on, draw on, or otherwise annotate a shared screen. In further examples, such annotations may be saved and persisted after the synchronous multimedia collaboration session has ended. A canvas may be created directly from a synchronous multimedia collaboration session to further enhance the collaboration between users.

In some examples, a user may start a synchronous multimedia collaboration session via a toggle in synchronous multimedia collaboration session pane 216 shown in FIG. 2B. Once a synchronous multimedia collaboration session has been started, synchronous multimedia collaboration session pane 216 may be expanded to provide information about the synchronous multimedia collaboration session such as how many members are present, which user is currently talking, which user is sharing the user's screen, and/or screen share preview 232. In some examples, users in the synchronous multimedia collaboration session may be displayed with an icon indicating that they are participating in the synchronous multimedia collaboration session. In further examples, an expanded view of the participants may show which users are active in the synchronous multimedia collaboration session and which are not. Screen share preview 232 may depict the desktop view of a user sharing the user's screen, or a particular application or presentation. Changes to the user's screen, such as the user advancing to the next slide in a presentation, will automatically be depicted in screen share preview 232. In some examples, the screen share preview 232 may be actuated to cause the screen share preview 232 to be enlarged such that it is displayed as its own pane within the group-based communication system. In some examples, the screen share preview 232 can be actuated to cause the screen share preview 232 to pop out into a new window or application separate and distinct from the group-based communication system. In some examples, the synchronous multimedia collaboration session pane 216 may comprise tools for the synchronous multimedia collaboration session allowing a user to mute the user's microphone or invite other users. In some examples, the synchronous multimedia collaboration session pane 216 may comprise a screen share button 234 that may permit a user to share the user's screen with other members of the synchronous multimedia collaboration session pane 216. In some examples, the screen share button 234 may provide a user with additional controls during a screen share. For example, a user sharing the user's screen may be provided with additional screen share controls to specify which screen to share, to annotate the shared screen, or to save the shared screen.

In some cases, the synchronous multimedia collaboration session pane 216 may persist in the navigation pane 206 regardless of the state of the group-based communication system. In some examples, when no synchronous multimedia collaboration session is active and/or depending on which item is selected from the navigation pane 206, the synchronous multimedia collaboration session pane 216 may be hidden or removed from being presented via the user interface 200. In some instances, when the pane 216 is active, the pane 216 can be associated with a currently selected channel, direct message, or multi-person direct message such that a synchronous multimedia collaboration session may be initiated and associated with the currently selected channel, direct message, or multi-person direct message.

A list of synchronous multimedia collaboration sessions may include one or more active synchronous multimedia collaboration sessions selected for recommendation. For example, the synchronous multimedia collaboration sessions may be selected from a plurality of currently active synchronous multimedia collaboration sessions. Further, the synchronous multimedia collaboration sessions may be selected based in part on user interaction with the sessions or some association of the instant user with the sessions or users involved in the sessions. For example, the recommended synchronous multimedia collaboration sessions may be displayed based in part on the instant user having been invited to a respective synchronous multimedia collaboration session or having previously collaborated with the users in the recommended synchronous multimedia collaboration session. In some examples, the list of synchronous multimedia collaboration sessions further includes additional information for each respective synchronous multimedia collaboration session, such as an indication of the participating users or number of participating users, a topic for the synchronous multimedia collaboration session, and/or an indication of an associated group-based communication channel, multi-person direct message conversation, or direct message conversation.

In some examples, a list of recommended active users may include a plurality of group-based communication system users recommended based on at least one of user activity, user interaction, or other user information. For example, the list of recommended active users may be selected based on an active status of the users within the group-based communication system; historic, recent, or frequent user interaction with the instant user (such as communicating within the group-based communication channel); or similarity between the recommended users and the instant user (such as determining that a recommended user shares common membership in channels with the instant user). In some examples, machine learning techniques such as cluster analysis can be used to determine recommended users. The list of recommended active users may include status user information for each recommended user, such as whether the recommended user is active, in a meeting, idle, in a synchronous multimedia collaboration session, or offline. In some examples, the list of recommended active users further comprises a plurality of actuatable buttons corresponding to some of or all the recommended users (for example, those recommended users with a status indicating availability) that, when selected, may be configured to initiate at least one of a text-based communication session (such as a direct message conversation) or a synchronous multimedia collaboration session.

In some examples, one or more recommended asynchronous multimedia collaboration sessions or meetings can be displayed in an asynchronous meeting section. By contrast with a synchronous multimedia collaboration session (described above), an asynchronous multimedia collaboration session allows each participant to collaborate at a time convenient to them. This collaboration participation is then recorded for later consumption by other participants, who can generate additional multimedia replies. In some examples, the replies are aggregated in a multimedia thread (for example, a video thread) corresponding to the asynchronous multimedia collaboration session. For example, an asynchronous multimedia collaboration session may be used for an asynchronous meeting where a topic is posted in a message at the beginning of a meeting thread and participants of the meeting may reply by posting a message or a video response. The resulting thread then comprises any documents, video, or other files related to the asynchronous meeting. In some examples, a preview of a subset of video replies may be shown in the asynchronous collaboration session or thread. This can allow, for example, a user to jump to a relevant segment of the asynchronous multimedia collaboration session or to pick up where they left off previously.

### Connecting Within the Group-Based Communication System

FIG. 2C illustrates user interface 200 displaying a connect pane 252. The connect pane 252 may provide tools and resources for users to connect across different organizations, where each organization may have their own (normally private) instance of the group-based communication system or may not yet belong to the group-based communication system. For example, a first software company may have a joint venture with a second software company with whom they wish to collaborate on jointly developing a new software application. The connect pane 252 may enable users to determine which other users and organizations are already within the group-based communication system, and to invite those users and organizations currently outside of the group-based communication system to join.

The connect pane 252 may comprise a connect search bar 254, recent contacts 256, connections 258, a create channel button 260, and/or a start direct message button 262. In some examples, the connect search bar 254 may permit a user to search for users within the group-based communication system. In some examples, only users from organizations that have connected with the user's organization will be shown in the search results. In other examples, users from any organization that uses the group-based communication system can be displayed. In still other examples, users from organizations that do not yet use the group-based communication can also be displayed, allowing the searching user to invite them to join the group-based communication system. In some examples, users can be searched for via their group-based communication system username or their email address. In some examples, email addresses may be suggested or autocompleted based on external sources of data such as email directories or the searching user's contact list.

In some examples, external organizations as well as individual users may be shown in response to a user search. External organizations may be matched based on an organization name or internet domain, as search results may include organizations that have not yet joined the group-based communication system (similar to searching and matching for a particular user, discussed above). External organizations may be ranked based in part on how many users from the user's organization have connected with users of the external organization. Responsive to a selection of an external organization in a search result, the searching user may be able to invite the external organization to connect via the group-based communication system.

In some examples, the recent contacts 256 may display users with whom the instant user has recently interacted. The recent contacts 256 may display the user's name, company, and/or a status indication. The recent contacts 256 may be ordered based on which contacts the instant user most frequently interacts with or based on the contacts with whom the instant user most recently interacted. In some examples each recent contact of the recent contacts 256 may be an actuatable control allowing the instant user to quickly start a direct message conversation with the recent contact, invite them to a channel, or take any other appropriate user action for that recent contact.

In some examples, the connections 258 may display a list of companies (e.g., organizations) with which the user has interacted. For each company, the name of the company may be displayed along with the company's logo and an indication of how many interactions the user has had with the company, for example the number of conversations. In some examples, each connection of the connections 258 may be an actuatable control allowing the instant user to quickly invite the external organization to a shared channel, display recent connections with that external organization, or take any other appropriate organization action for that connection.

In some examples, the create channel button 260 allows a user to create a new shared channel between two different organizations. Selecting the create channel button 260 may further allow a user to name the new connect channel and enter a description for the connect channel. In some examples, the user may select one or more external organizations or one or more external users to add to the shared channel. In other examples, the user may add external organizations or external users to the shared channel after the shared channel is created. In some examples, the user may elect whether to make the connect channel private (e.g., accessible only by invitation from a current member of the private channel).

In some examples, the start direct message button 262 allows a user to quickly start a direct message (or multi-person direct message) with external users at an external organization. In some examples, the external user identifier at an external organization may be supplied by the instant user as the external user's group-based communication system username or as the external user's email address. In some examples, an analysis of the email domain of the external user's email address may affect the message between the user and the external user. For example, the external user's identifier may indicate (for example, based on an email address domain) that the user's organization and the external user's organization are already connected. In some such examples, the email address may be converted to a group-based communication system username. Alternatively, the external user's identifier may indicate that the external user's organization belongs to the group-based communication system but is not connected to the instant user's organization. In some such examples, an invitation to connect to the instant user's organization may be generated in response. As another alternative, the external user may not be a member of the group-based communication system, and an invitation to join the group-based communication system as a guest or a member may be generated in response.

### Collaborative Documents

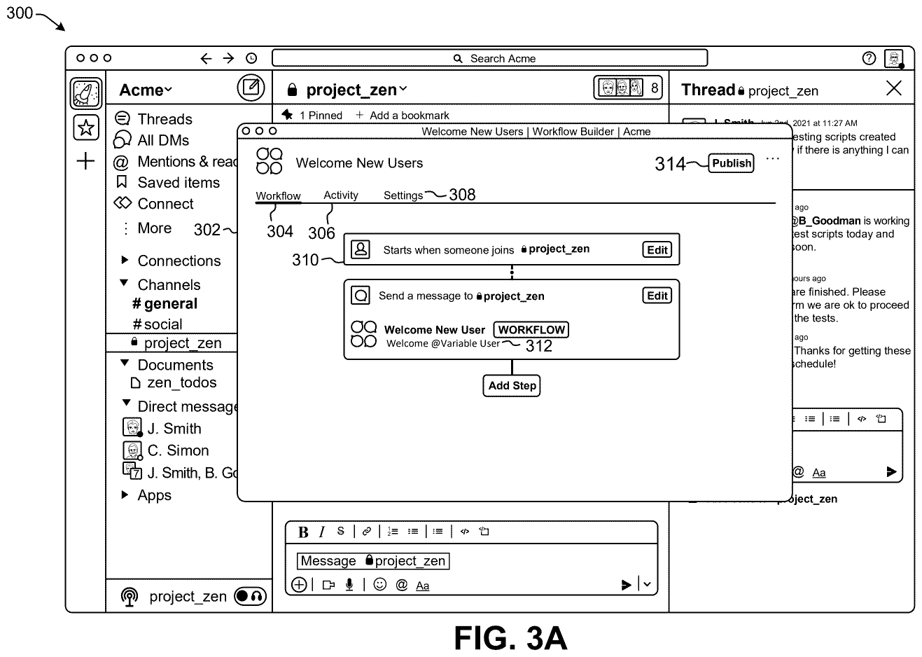

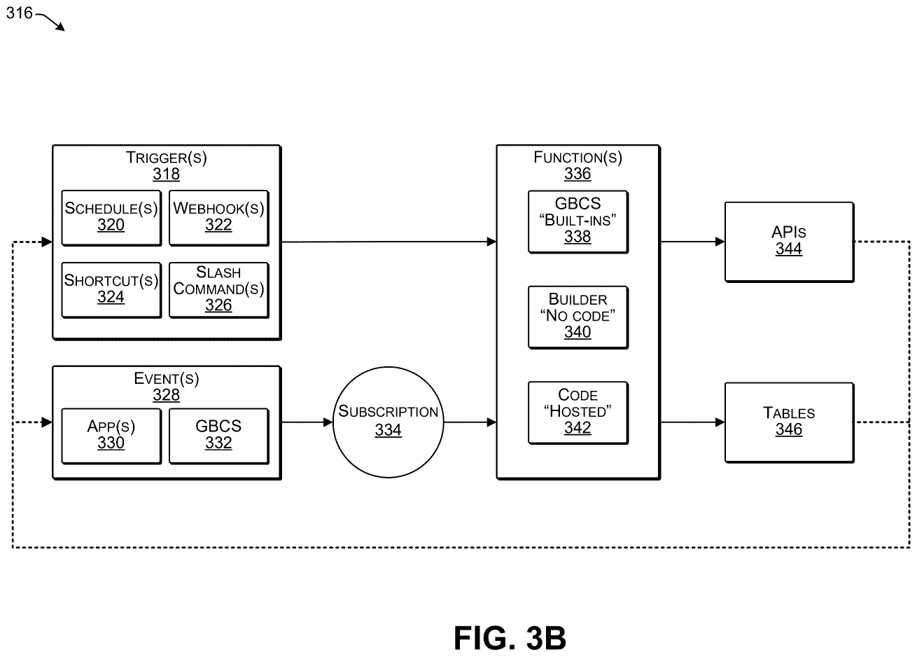

FIG. 2D illustrates user interface 200 displaying a collaboration document pane 264. A collaborative document may be any file type, such as a PDF, video, audio, word processing document, etc., and is not limited to a word processing document or a spreadsheet. A collaborative document may be modified and edited by two or more users. A collaborative document may also be associated with different user permissions, such that based on a user's permissions for the document (or sections of the document as discussed below), the user may selectively be permitted to view, edit, or comment on the collaborative document (or sections of the collaborative document). As such, users within the set of users having access to the document may have varying permissions for viewing, editing, commenting, or otherwise interfacing with the collaborative document. In some examples, permissions can be determined and/or assigned automatically based on how document(s) are created and/or shared. In some examples, permission can be determined manually. Collaborative documents may allow users to simultaneously or asynchronously create and modify documents. Collaborative documents may integrate with the group-based communication system and can both initiate workflows and be used to store the results of workflows, which are discussed further below with respect to FIGS. 3A and 3B.

In some examples, the user interface 200 can comprise one or more collaborative documents (or one or more links to such collaborative documents). A collaborative document (also referred to as a document or canvas) can include a flexible workspace for curating, organizing, and sharing collections of information between users. Such documents may be associated with a synchronous multimedia collaboration session, an asynchronous multimedia collaboration session, a channel, a multi-person direct message conversation, and/or a direct message conversation. Shared canvases can be configured to be accessed and/or modified by two or more users with appropriate permissions. Alternatively or in addition, a user might have one or more private documents that are not associated with any other users.

Further, such documents can be @mentioned, such that particular documents can be referred to within channels (or other virtual spaces or documents) and/or other users can be @mentioned within such a document. For example, @mentioning a user within a document can provide an indication to that user and/or can provide access to the document to the user. In some examples, tasks can be assigned to a user via an @mention and such task(s) can be populated in the pane or sidebar associated with that user.

In some examples, a channel and a collaborative document 268 can be associated such that when a comment is posted in a channel it can be populated to a document 268, and vice versa.

In some examples, when a first user interacts with a collaborative document, the communication platform can identify a second user account associated with the collaborative document and present an affordance (e.g., a graphical element) in a sidebar (e.g., the navigation pane 206) indicative of the interaction. Further, the second user can select the affordance and/or a notification associated with or representing the interaction to access the collaborative document, to efficiently access the document and view the update thereto.

In some examples, as one or more users interact with a collaborative document, an indication (e.g., an icon or other user interface element) can be presented via user interfaces with the collaborative document to represent such interactions. For examples, if a first instance of the document is presently open on a first user computing device of a first user, and a second instance of the document is presently open on a second user computing device of a second user, one or more presence indicators can be presented on the respective user interfaces to illustrate various interactions with the document and by which user. In some examples, a presence indicator may have attributes (e.g., appearance attributes) that indicate information about a respective user, such as, but not limited to, a permission level (e.g., edit permissions, read-only access, etc.), virtual-space membership (e.g., whether the member belongs to a virtual space associated with the document), and the manner in which the user is interacting with the document (e.g., currently editing, viewing, open but not active, etc.).

In some examples, a preview of a collaborative document can be provided. In some examples, a preview can comprise a summary of the collaborative document and/or a dynamic preview that displays a variety of content (e.g., as changing text, images, etc.) to allow a user to quickly understand the context of a document. In some examples, a preview can be based on user profile data associated with the user viewing the preview (e.g., permissions associated with the user, content viewed, edited, created, etc. by the user), and the like.

In some examples, a collaborative document can be created independent of or in connection with a virtual space and/or a channel. A collaborative document can be posted in a channel and edited or interacted with as discussed herein, with various affordances or notifications indicating presence of users associated with documents and/or various interactions.

In some examples, a machine learning model can be used to determine a summary of contents of a channel and can create a collaborative document comprising the summary for posting in the channel. In some examples, the communication platform may identify the users within the virtual space, actions associated with the users, and other contributions to the conversation to generate the summary document. As such, the communication platform can enable users to create a document (e.g., a collaborative document) for summarizing content and events that transpired within the virtual space.

In some examples, documents can be configured to enable sharing of content including (but not limited to) text, images, videos, GIFs, drawings (e.g., user-generated drawings via a drawing interface), or gaming content. In some examples, users accessing a canvas can add new content or delete (or modify) content previously added. In some examples, appropriate permissions may be required for a user to add content or to delete or modify content added by a different user. Thus, for example, some users may only be able to access some or all of a document in view-only mode, while other users may be able to access some or all of the document in an edit mode allowing those users to add or modify its contents. In some examples, a document can be shared via a message in a channel, multi-person direct message, or direct message, such that data associated with the document is accessible to and/or rendered interactable for members of the channel or recipients of the multi-person direct message or direct message.

In some examples, the collaboration document pane 264 may comprise collaborative document toolbar 266 and collaborative document 268. In some examples, collaborative document toolbar 266 may provide the ability to edit or format posts, as discussed herein.

In some examples, collaborative documents may comprise free-form unstructured sections and workflow-related structured sections. In some examples, unstructured sections may include areas of the document in which a user can freely modify the collaborative document without any constraints. For example, a user may be able to freely type text to explain the purpose of the document. In some examples, a user may add a workflow or a structured workflow section by typing the name of (or otherwise mentioning) the workflow. In further examples, typing the “at” sign (@), a previously selected symbol, or a predetermined special character or symbol may provide the user with a list of workflows the user can select to add to the document. For example, a user may indicate that a marketing team member needs to sign off on a proposal by typing “! Marketing Approval” to initiate a workflow that culminates in a member of the marketing team approving the proposal. Placement of an exclamation point prior to the group name of “Marketing Approval” initiates a request for a specification action, in this case routing the proposal for approval. In some examples, structured sections may include text entry, selection menus, tables, checkboxes, tasks, calendar events, or any other document section. In further examples, structured sections may include text entry spaces that are a part of a workflow. For example, a user may enter text into a text entry space detailing a reason for approval, and then select a submit button that will advance the workflow to the next step of the workflow. In some examples, the user may be able to add, edit, or remove structured sections of the document that make up the workflow components.

In examples, sections of the collaborative document may have individual permissions associated with them. For example, a collaborative document having sections with individual permissions may provide a first user permission to view, edit, or comment on a first section, while a second user does not have permission to view, edit, or comment on the first section. Alternatively, a first user may have permissions to view a first section of the collaborative document, while a second user has permissions to both view and edit the first section of the collaborative document. The permissions associated with a particular section of the document may be assigned by a first user via various methods, including manual selection of the particular section of the document by the first user or another user with permission to assign permissions, typing or selecting an “assignment” indicator, such as the “@” symbol, or selecting the section by a name of the section. In further examples, permissions can be assigned for a plurality of collaborative documents at a single instance via these methods. For example, a plurality of collaborative documents each has a section entitled “Group Information,” where the first user with permission to assign permissions desires an entire user group to have access to the information in the “Group Information” section of the plurality of collaborative documents. In examples, the first user can select the plurality of collaborative documents and the “Group Information” section to effectuate permissions to access (or view, edit, etc.) to the entire user group the “Group Information” section of each of the plurality of collaborative documents.

### Automation in the Group-Based Communication System

FIG. 3A illustrates user interface 300 for automation in the group-based communication system. Automation, also referred to as workflows, allow users to automate functionality within the group-based communication system. Workflow builder 302 is depicted which allows a user to create new workflows, modify existing workflows, and review the workflow activity. Workflow builder 302 may comprise a workflow tab 304, an activity tab 306, and/or a settings tab 308. In some examples, workflow builder may include a publish button 314 which permits a user to publish a new or modified workflow.

The workflow tab 304 may be selected to enable a user to create a new workflow or to modify an existing workflow. For example, a user may wish to create a workflow to automatically welcome new users who join a channel. A workflow may comprise workflow steps 310. Workflow steps 310 may comprise at least one trigger which initiates the workflow and at least one function which takes an action once the workflow is triggered. For example, a workflow may be triggered when a user joins a channel and a function of the workflow may be to post within the channel welcoming the new user. In some examples, workflows may be triggered from a user action, such as a user reacting to a message, joining a channel, or collaborating in a collaborative document, from a scheduled date and time, or from a web request from a third-party application or service. In further examples, workflow functionality may include sending messages or forms to users, channels, or any other virtual space, modifying collaborative documents, or interfacing with applications. Workflow functionality may include workflow variables 312. For example, a welcome message may include a user's name via a variable to allow for a customized message. Users may edit existing workflow steps or add new workflow steps depending on the desired workflow functionality. Once a workflow is complete, a user may publish the workflow using publish button 314. A published workflow will wait until it is triggered, at which point the functions will be executed.

Activity tab 306 may display information related to a workflow's activity. In some examples, the activity tab 306 may show how many times a workflow has been executed. In further examples, the activity tab 306 may include information related to each workflow execution including the status, last activity date, time of execution, user who initiated the workflow, and other relevant information. The activity tab 306 may permit a user to sort and filter the workflow activity to find useful information.

A settings tab 308 may permit a user to modify the settings of a workflow. In some examples, a user may change a title or an icon associated with the workflow. Users may also manage the collaborators associated with a workflow. For example, a user may add additional users to a workflow as collaborators such that the additional users can modify the workflow. In some examples, settings tab 308 may also permit a user to delete a workflow.

FIG. 3B depicts elements related to workflows in the group-based communication system and is referred to generally by reference numeral 316. In various examples, trigger(s) 318 can be configured to invoke execution of function(s) 336 responsive to user instructions. A trigger initiates function execution and may take the form of one or more schedule(s) 320, webhook(s) 322, shortcut(s) 324, and/or slash command(s) 326. In some examples, the schedule 320 operates like a timer so that a trigger may be scheduled to fire periodically or once at a predetermined point in the future. In some examples, an end user of an event-based application sets an arbitrary schedule for the firing of a trigger, such as once-an-hour or every day at 9:15 AM.

Additionally, triggers 318 may take the form of the webhook 322. The webhook 322 may be a software component that listens at a webhook URL and port. In some examples, a trigger fires when an appropriate HTTP request is received at the webhook URL and port. In some examples, the webhook 322 requires proper authentication such as by way of a bearer token. In other examples, triggering will be dependent on payload content.

Another source of one of the trigger(s) 318 is a shortcut in the shortcut(s) 324. In some examples, the shortcut(s) 324 may be global to a group-based communication system and are not specific to a group-based communication system channel or workspace. Global shortcuts may trigger functions that are able to execute without the context of a particular group-based communication system message or group-based communication channel. By contrast, message- or channel-based shortcuts are specific to a group-based communication system message or channel and operate in the context of the group-based communication system message or group-based communication channel.

A further source of one of triggers 318 may be provided by way of slash commands 326. In some examples, the slash command(s) 326 may serve as entry points for group-based communication system functions, integrations with external services, or group-based communication system message responses. In some examples, the slash commands 326 may be entered by a user of a group-based communication system to trigger execution of application functionality. Slash commands may be followed by slash-command-line parameters that may be passed along to any group-based communication system function that is invoked in connection with the triggering of a group-based communication system function such as one of functions 336.

An additional way in which a function is invoked is when an event (such as one of events 328) matches one or more conditions as predetermined in a subscription (such as subscription 334). Events 328 may be subscribed to by any number of subscriptions 334, and each subscription may specify different conditions and trigger a different function. In some examples, events are implemented as group-based communication system messages that are received in one or more group-based communication system channels. For example, all events may be posted as non-user visible messages in an associated channel, which is monitored by subscriptions 334. App events 330 may be group-based communication system messages with associated metadata that are created by an application in a group-based communication system channel. Events 328 may also be direct messages received by one or more group-based communication system users, which may be an actual user or a technical user, such as a bot. A bot is a technical user of a group-based communication system that is used to automate tasks. A bot may be controlled programmatically to perform various functions. A bot may monitor and help process group-based communication system channel activity as well as post messages in group-based communication system channels and react to members' in-channel activity. Bots may be able to post messages and upload files as well as be invited or removed from both public and private channels in a group-based communication system.

Events 328 may also be any event associated with a group-based communication system. Such group-based communication system events 332 include events relating to the creation, modification, or deletion of a user account in a group-based communication system or events relating to messages in a group-based communication system channel, such as creating a message, editing or deleting a message, or reacting to a message. Events 328 may also relate to creation, modification, or deletion of a group-based communication system channel or the membership of a channel. Events 328 may also relate to user profile modification or group creation, member maintenance, or group deletion.

As described above, subscription 334 indicates one or more conditions that, when matched by events, trigger a function. In some examples, a set of event subscriptions is maintained in connection with a group-based communication system such that when an event occurs, information regarding the event is matched against a set of subscriptions to determine which (if any) of functions 336 should be invoked. In some examples, the events to which a particular application may subscribe are governed by an authorization framework. In some instances, the event types matched against subscriptions are governed by OAuth permission scopes that may be maintained by an administrator of a particular group-based communication system.

In some examples, functions 336 can be triggered by triggers 318 and events 328 to which the function is subscribed. Functions 336 take zero or more inputs, perform processing (potentially including accessing external resources), and return zero or more results. Functions 336 may be implemented in various forms. First, there are group-based communication system built-ins 338, which are associated with the core functionality of a particular group-based communication system. Some examples include creating a group-based communication system user or channel. Second are no-code builder functions 340 that may be developed by a user of a group-based communication system user in connection with an automation user interface such as workflow builder user interface. Third, there are hosted-code functions 342 that are implemented by way of group-based communication system applications developed as software code in connection with a software development environment.

These various types of functions 336 may in turn integrate with APIs 344. In some examples, APIs 344 are associated with third-party services that functions 336 employ to provide a custom integration between a particular third-party service and a group-based communication system. Examples of third-party service integrations include video conferencing, sales, marketing, customer service, project management, and engineering application integration. In such an example, one of the triggers 318 would be a slash command 326 that is used to trigger a hosted-code function 342, which makes an API call to a third-party video conferencing provider by way of one of the APIs 344. As shown in FIG. 3B, the APIs 344 may themselves also become a source of any number of triggers 318 or events 328. Continuing the above example, successful completion of a video conference would trigger one of the functions 336 that sends a message initiating a further API call to the third-party video conference provider to download and archive a recording of the video conference and store it in a group-based communication system channel.

In addition to integrating with APIs 344, functions 336 may persist and access data in tables 346. In some examples, tables 346 are implemented in connection with a database environment associated with a serverless execution environment in which a particular event-based application is executing. In some instances, tables 346 may be provided in connection with a relational database environment. In other examples, tables 346 are provided in connection with a database mechanism that does not employ relational database techniques. As shown in FIG. 3B, in some examples, reading or writing certain data to one or more of tables 346, or data in table matching predefined conditions, is itself a source of some number of triggers 318 or events 328. For example, if tables 346 are used to maintain ticketing data in an incident-management system, then a count of open tickets exceeding a predetermined threshold may trigger a message being posted in an incident-management channel in the group-based communication system.

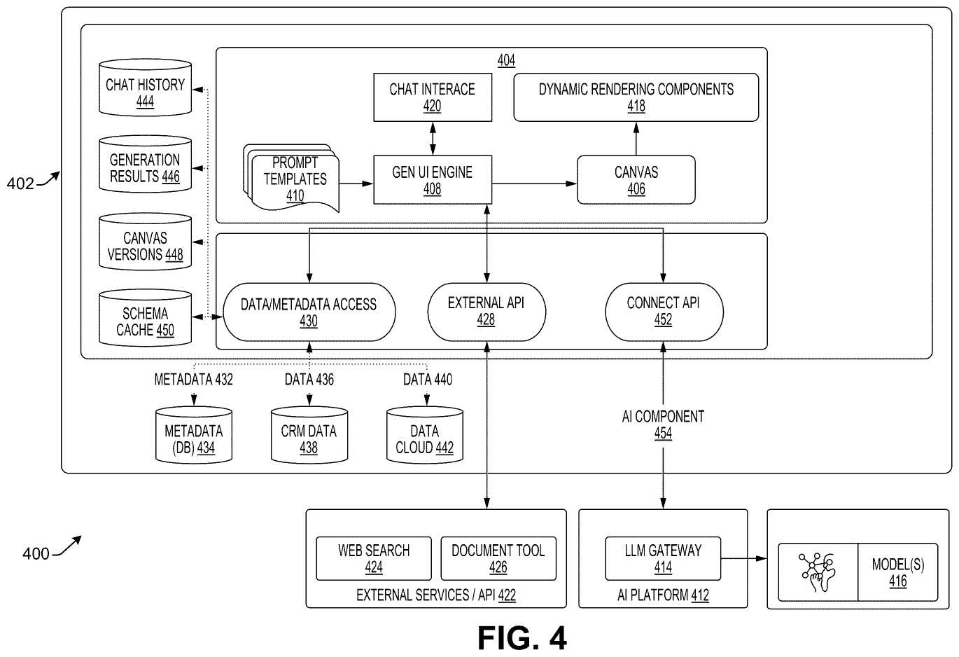

FIG. 4 illustrates an example architecture for generating and maintaining a canvas virtual space utilizing one or more machine-learned models and/or generative AI models. The canvas virtual space may be highly personalized with respect to a user and both dynamic and adaptive to updated information/data associated with a topic, project, event, etc. associated with the canvas virtual space. The canvas virtual space may represent a single space in which relevant content associated with a topic, project, event, etc. associated with the canvas virtual space is presented to a user or a group of users.

As an illustrative example, assume that a user is a salesperson and the user is meeting with an organization that could be a potential client or business partner. In order to research the organization, the user may need to conduct research to learn information about the organization and to understand the product/services that the organization offers. Via this research, the user may conduct searches within a search engine, navigate to different websites, review both public and internal sources/documents, and/or review transcripts of previous meetings with the organization. Provided that the user is meeting with various stakeholders of the organization, the user may also desire to research each of the stakeholders prior to the meeting in order to understand their background and to identify talking points that allows the user to relate to the stakeholders. As a result, the user is forced to navigate between many different sources to obtain relevant information, resulting in a “swivel chair” experience that is time consuming and resource intensive. For instance, a significant amount of computing resources are required to navigate and toggle between different sources to obtain the information that the user needs. In other words, computing resources of the device being utilized by the user, as well as one or more servers that facilitate the user accessing such resources, are consumed by the user attempting to find relevant information by accessing a first resource (e.g., an internal document), then accessing a second resource (e.g., a website), then accessing a third resource (e.g., a communication channel of a group-based communication platform), then accessing a fourth resource (e.g., email folders), and so on. Consumption of such computing resources would likely result in latency across different networks and different users, additional storage requirements to initially store and maintain the relevant content, and a reduction in network bandwidth.

By retrieving relevant content from many different resources, aggregating the relevant content, and dynamically rendering the relevant content within a single user interface (e.g., the canvas virtual space), the user need only access a single user interface to access and view the relevant content responsive to a query, prompt, or topic of interest of the user. As a result, the user need not navigate, and toggle between, different resources, thereby reducing computing resources consumed by the user. Since the relevant content is stored in association with the canvas virtual space, the user need not store all of the relevant content identified from the different resources, thereby reducing storage requirements. Moreover, since the user is not navigating between different resources, the user will not be consuming as much network resources, resulting in additional network bandwidth for other users and corresponding devices.

Furthermore, the systems and processes described therein provide one or more technological solutions to one or more technological problems. For instance, users are able to access and retrieve information from millions and millions of documents, websites, resources, etc. across different networks and the Internet. As a result, due to the immense amount of information available to users, the ability to identify, retrieve, aggregate, and store data responsive to a query is incredibly difficult, time consuming, and resource intensive. Moreover, it is difficult for a user to know where to start their research, to identify which resources to access, and to determine when their research is complete. The systems and processes described herein utilize one or more models (e.g., generative AI models, LLMs, machine learning models, etc.) to identify a topic of interest of a user (based on a query, for instance), retrieve relevant content for the topic, and dynamically render the content within a canvas virtual space having organized tiles that are directed to different aspects of the topic. Moreover, based on additional requests of the user and based on new information/data becoming available, the systems and processes described herein may dynamically update the content within the canvas virtual space so that the content remains current and relevant. The user need not perform any research and the content relevant to their query is accessible via a single user interface at the fingertips of the user.

With respect to the example described above, the systems and processes described herein may generate a canvas virtual space utilizing one or more machine-learned models, large language models, and/or generative AI models. The canvas virtual space may automatically incorporate the relevant content referenced above. For instance, the canvas virtual space may include different tiles/sections that display relevant content relating to the organization itself, the products/services offered by the organization, the stakeholders, a summary of previous meetings, business objectives, upcoming deadlines, and so on. As a result, the user may access a single source (i.e., the canvas virtual space) to access and consume the necessary relevant information relating to the potential opportunity with the potential client/business partner. Instead of the user needing perform research and find such relevant information via multiple pages and/or websites, the canvas virtual space may serve as a dynamic generative user interface where the relevant content is assembled and is available at the fingertips of the user.

As another illustrative example, assume that a user is planning a trip to Greece. To plan this trip and to obtain all the necessary information (e.g., transportation, itinerary, lodging, food options, attractions, tour options, etc.), the user may need to read travel books on Greece, visit websites, read reviews, etc. Instead, the user may input a request regarding travel to Greece (e.g., “I want to plan a vacation to Greece”), and the systems and processes described herein may generate a canvas virtual space that includes relevant content needed to plan such a trip. For example, the canvas virtual space may include content relating to transportation (e.g., air travel to Greece, travel within Greece, etc.), example/suggested itineraries, lodging options, recommended restaurants, potential tour guides, activities, and so on. Therefore, instead of the user having to navigate to multiple different sources and websites, the user can instead simply enter text input or a query, and a canvas virtual space will be generated for the user, where the canvas virtual space identifies and displays various types of content relevant to the text input/query. For instance, the canvas virtual space may have separate tiles devoted to different aspects of a trip to Greece, such as a first tile including content related to transportation options, a second tile including content related to lodging options, a third tile including content related to different itineraries within Greece, and so on. As a result, the user may plan a trip to Greece utilizing a single resource.

FIG. 4 illustrates an architecture 400 for generating the canvas virtual space (or otherwise referred to as “canvas” 406). Components and/or modules within 402 are maintained by, or associated with, one or more servers associated with a service provider that generates and maintains the canvas virtual space 406. Within box 404 resides a gen user interface (UI) engine 408, also referred to herein as a generative UI service. The gen UI engine 408 determines which sections and/or components are displayed within the canvas virtual space 406. The gen UI engine 408 utilizes one or more prompt templates 410 to determine how and/or where the tiles, sections, and/or components are to be rendered and displayed within the canvas virtual space 406. The gen UI engine 408 also utilizes the prompt template(s) 410 to determine which content is to be included and rendered within the tiles, sections, and/or components of the canvas virtual space 406.

The architecture 400 also includes an AI platform 412 including an LLM gateway 414 that is associated with the service provider. The gen UI engine 408 may call the LLM gateway 414 in order to leverage one or more models 416 utilized to generate the canvas virtual space 406 and the components, sections, and content rendered within the canvas virtual space 406. In some embodiments, the model(s) 416 are called to determine the content to be rendered within the canvas virtual space 406. The model(s) 416 may include LLM models, generative AI models, machine-learned models, and so on. Specific examples of such models may include OpenAI® and/or Vertex AI®. The service provider may utilize one or more rendering components 418 to determine how to render the components, sections, and/or content within the canvas virtual space 406. For instance, the dynamic rendering component(s) 418 may identify a location in the canvas virtual space 406 where the different tiles/components/sections are to reside, may dynamically move or reposition the tiles/components/sections within the canvas virtual space 406, and/or can determine the proper size of the tiles/components/sections based on the display size of the device being utilized to access the canvas virtual space 406 (e.g., mobile telephone, laptop computer, tablet device, etc.). In some embodiments, the dynamic rendering component(s) 418 may determine a default position or location of the different tiles/components/sections, and the user may reposition or reorient the tiles/components/sections, adjust the size of the tiles/components/sections, and make other adjustments to the appearance of the tiles/components/sections within the canvas virtual space 406.

The models 416 may include any type of machine learning models, large language models (LLM) (e.g., LLM-based models), generative AI models, neural networks, artificial neural networks, decision trees, support-vector machines, regression analysis, Gaussian processes, convolution neural networks, recurrent neural networks, Bayesian neural networks, foundation models, ensemble models, transformers, encoders/decoders, and so on. The service provider that provides the canvas virtual space 406 may utilize data maintained by the service provider to train untrained or pre-trained models to generate trained models. For instance, the service provider may include functionality to receive real data, modified data, and/or simulated data to train one or more untrained neural networks to generate a plurality of trained neural networks. During training, weights, filters, connections between layers, and/or parameters may be adjusted for training the individual untrained neural networks to perform a task. In some instances, supervised learning/training, unsupervised learning/training, semi-supervised learning/training, reinforcement learning/training, feature learning/training, federated learning/training, and/or self learning/training may be utilized.

Additional or alternate examples of architectures may include neural networks such as ResNet-50, ResNet-101, VGG, DenseNet, PointNet, Xception, ConvNeXt, and the like; visual transformer(s) (ViT(s)), such as a bidirectional encoder from image transformers (BEiT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, RoBERTa, XLNet, GPT-2, GPT-3, or the like.

Moreover, in various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Referring back to FIG. 4, a chat interface 420 may be utilized to determine the topic, content, project, subject matter, etc. that the canvas virtual space 406 should relate to. For example, the chat interface 420 may be a text entry field where the user can input text (e.g., one or more words or phrases, a sentence, a paragraph, etc.) that instructs the gen UI engine 408 to identify the different sections/components that are to be included in the canvas virtual space 406 and the type and amount of content that is to be included within each tile/section/component. Example requests input by the user may include “I am planning a trip to Greece” or “include information about potential client ABC Corp.” The chat interface 420 may also include suggested prompts that are selectable by the user to generate the canvas virtual space 406. For instance, the suggested prompts may related to different topics, subject matter, projects, etc. that are determined to be relevant to the user. The chat interface 420 may reside on a first page that is utilized to generate the canvas virtual space 406, and the chat interface 420 may be included within the canvas virtual space 406 in order to allow the user to identify other content, subject matter, topics, etc. that are to be included within the canvas virtual space 406. For instance, once the canvas virtual space 406 has been generated, the user may determine that other content or topics should also be included. Either via a text entry into the chat interface 420 or a selection of a suggested prompt, an additional tile/section/component with content responsive to the text entry or selection may be added to the canvas virtual space 406. In addition, individual ones of the sections/components within the canvas virtual space 406 may include a chat interface 420 so that the user can add content and/or customize the content within a specific one of the tiles/sections/components. For example, within a particular tile/section/component, the user may ask “can you regenerate the content and focus it more on this area?”

In some embodiments, the model(s) 416 may receive the text input by the user or a selected suggested prompt as input. The trained model(s) 416 may analyze the input in order to output information that is responsive to the initial query by the user. Here, the output of the model(s) may include the topic that is responsive to the initial query, different aspects that are relevant to the topic, specific tiles that are based on those different aspects, and content that is to be included within each tile. In addition, the model(s) 416 may output a layout of the tiles within the canvas virtual space 406, as well as the size of the tiles and the type and amount of content that is to be included in each tile.

The gen UI engine 408 may also utilize one or more external services/APIs 422 that allow for additional information to be obtained from, and included within, the canvas virtual space 406. For instance, web search 424 may be utilized to obtain information from one or more external websites. Such information may include information obtained from a website of a potential client or business partner, information about a product/service of the potential client/business partner, information about one or more stakeholders of the potential client/business partner, and so on. The external services/API 422 may also include a document tool 426 that allows a user to upload documents (e.g., PDF files, Word documents, .txt files, PowerPoint documents/slides, etc.) to the canvas virtual space 406. Upon a document being uploaded, the document tool 422 may analyze the document, extract information from the document, provide a summary of the document, suggest questions that the user may ask regarding the document, and/or provide one or more suggested changes or revisions to the document. Such information relating to the uploaded document may be presented within a section/component of the canvas virtual space 406. In some embodiments, with respect to providing a summary of the document, the user may provide a custom prompt that provides instructions or specificity regarding the summary. For example, the user may prompt the canvas virtual space to identify key action items of the document (e.g., “what are the key action items?”). The service provider may interact with the external services/API 422 via an external API 428 maintained by the service provider.

In order for the gen UI engine 408 to render the responsive and requested information within the canvas virtual space 406, the gen UI engine 408 may obtain various types of data via a data/metadata/access 430 component. For instance, metadata 432 may be obtained from a metadata database (DB) 434, data 436 may be obtained from customer relationship management (CRM) data 438, and data 440 may be obtained from data cloud 442. Each of these types of data may be incorporated within the prompt template(s) 410, which allows the gen UI engine 408 to determine which sections/components to render within the canvas virtual space 406 and which content to render within each of the sections components. For the purposes of this disclosure, CRM may refer to systems, platforms, and/or processes that help an organization manage and improve interactions with customers and/or potential customers.

The architecture 400 further includes chat history 444 that corresponds to prompts and text inputs provided by the user, including the initial prompts/inputs to generate the canvas virtual space 406 and prompts/inputs provided by the user to the canvas virtual space 406 (or sections/compartments thereof) after the canvas virtual space 406 has been generated. That way, the system can store previous layouts and modifications to the canvas virtual space 406 and can subsequently dynamically present the canvas virtual space 406 to the user in a preferred manner. That is, the chat history 444 may represent historical data of the user with respect to the canvas virtual space 406 such that subsequent iterations of the canvas virtual space 406, including the tiles, sections, compartments, and/or content of the canvas virtual space 406 are consistent with previous iterations of the canvas virtual space 406. Generation results 446 may correspond to previous instances regarding how the canvas virtual space was generated. Canvas versions 448 may correspond to different versions of the canvas virtual space 406 over time. And schema cache 450 may correspond to a history of schemas utilized to generate instances of the canvas virtual space 406. Schemas within the schema cache 450 may be utilized to generate subsequent iterations of the canvas virtual space 406.

As referenced above, the AI platform 412 and the LLM gateway 414 may be utilized to access the model(s) 416. A connect API 452 and an AI component 454 may allow the gen UI engine 408 to access and be connected with the model(s) 416.

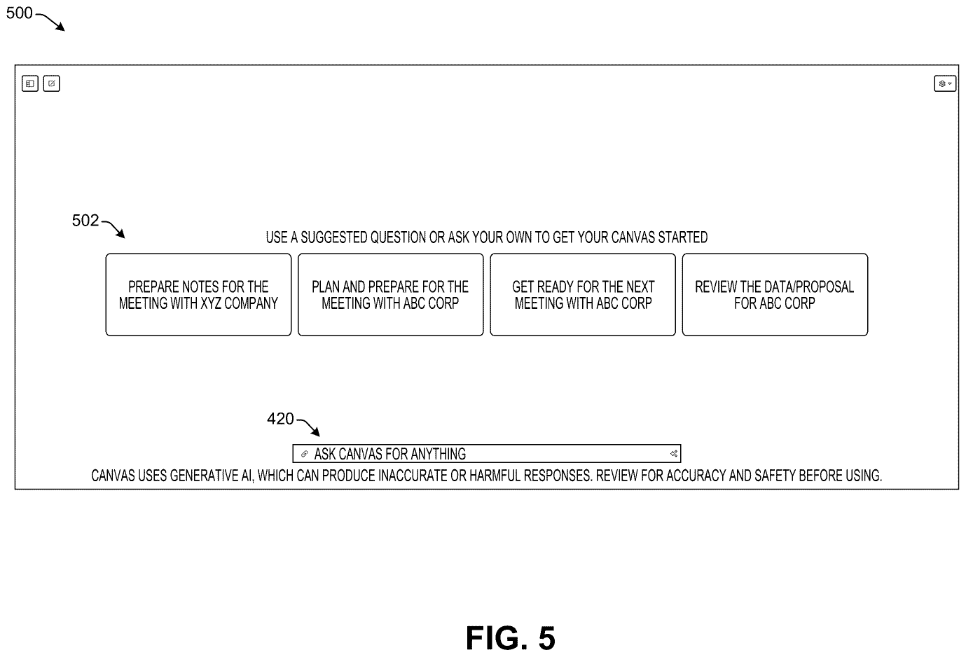

FIG. 5 illustrates a user interface 500 that may be presented to the user for the purpose of generating the canvas virtual space 406. As shown, the user interface 500 may include the chat interface 420. The user may enter any text (e.g., natural language text, keywords, phrases, queries, questions, prompts, etc.) within the chat interface 420 for the purpose of allowing the service provider to identify the topic, project, account, event, etc. that the canvas virtual space 406 is to be associated with. For the purposes of this discussion, the user may also enter, or attach, other types of information within the chat interface 420, such as documents, images, photographs, links, etc. Based on the information inputted into the chat interface 420 by the user, the service provider may generate the canvas virtual space 406 responsive to that information, such that the canvas virtual space 406 includes tiles/sections/components that relate to different aspects associated with the identified topic, as well as relevant content within each of the sections/components. In particular, the model(s) 416 may receive the text inputted by the user as input, process/analyze the inputted text, and return categories of responsive information and content that is associated with each of the categories. Each category may be represented by a tile within the canvas virtual space 406 and the corresponding content may be included within that tile. In addition, the model(s) 416 may output a layout or configuration of the tiles within the canvas virtual space 406.

Alternatively, or in addition to the chat interface 420, the user interface 500 may include one or more suggested prompts 502 that could be utilized to generate the canvas virtual space 406. Upon user selection of one of the suggested prompts 502, the service provider may generate a canvas virtual space 406 relating to the selected suggested prompt 502. The content of the suggested prompts 502 may be based on information associated with the user that is viewing the user interface 502, such as a role/position of the user, a user profile of the user, accounts that the user is currently handling or has previously handed, previous canvas virtual spaces 406 generated for the user, actions previously taken by the user, conversations with other users within a group-based communication platform, including messages sent or posted by the user and messages received by the user via the group-based communication platform, calendar data, and so on. As shown, the suggested prompts 502 depicted in the user interface 502 include “prepare notes for the meeting with XYZ company,” “plan and prepare for the meeting with ABC Corp,” “get ready for the next meeting with ABC Corp,” and “review the data/proposal for ABC Corp,” although any number of suggested prompts 502 may be presented to the user via the user interface 500. For example, if the user is a salesperson at a company, the canvas virtual space 406 may include content similar to other salespeople at the company. Although the tiles for the suggested prompts 502 are included towards the center of the user interface 500 and the chat interface 420 is depicted towards the bottom of the user interface 500, it is contemplated that the suggested prompts 502 and the chat interface 420 can reside in any area of the user interface 500 in any configuration, size, shape, and so on.

As an illustrative example, assuming that the user is associated with multiple user accounts, the suggested prompts 502 may relate to those accounts. If the user selects one of the suggested prompts 502 associated with a particular one of the user accounts, the user may be directed to a canvas virtual space 406 that is specifically related to that account, and that includes sections, components, content, etc. specific to that account. The resulting canvas virtual space 406 may include tiles/sections/components relating to different aspects of the account (e.g., upcoming deadlines, a history of conversations, financial information, key stakeholders, etc.). Alternatively, instead of selecting a particular one of the suggested prompts 502, the user may enter text relating to an account, such as “help me prepare for my upcoming meeting with account xyz.” The user interface 500 may also include a section that allows the user to launch existing canvas virtual spaces 406 that were previously generated for, and accessed by, the user.

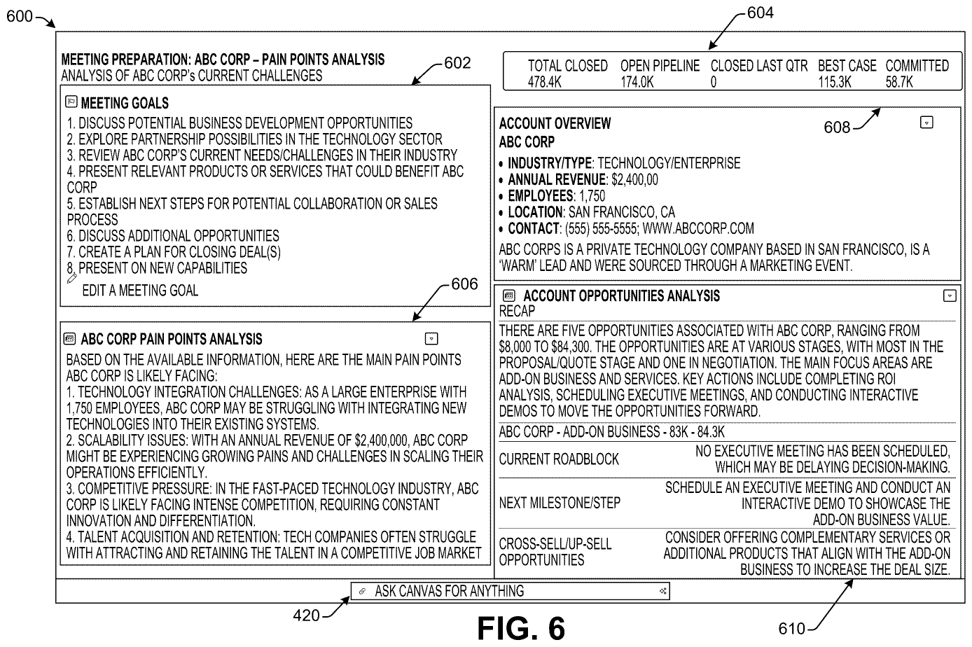

FIG. 6 illustrates a user interface 600 representing the canvas virtual space 406. As shown, the canvas virtual space 406 may include the chat interface 420. Moreover, the canvas virtual space 406 may include one or more tiles (ref. nos. 602-610; also referred to herein as sections or components) that each include different types of content. Each tile may be related to a different aspect of the topic associated with the canvas virtual space 406 and the content within each tile 602-610 may be related to the topic of that particular tile. The canvas virtual space 406 may have any number of tiles 602-610, the tiles 602-610 can vary in size and be in different layouts and configurations, and the amount of content within each tile 602-610 may vary, which may all be based on preferences of the user, specific actions taken by the user (e.g., moving or rearranging tiles, reducing/enlarging the size of the tiles, adding or removing content from the tiles, etc.). In some embodiments, the chat interface 420 may also be located within individual ones of the tiles (ref. nos. 602-610). As a result of the initial input into the chat interface 420 and/or the selection of a suggested prompt 502, as depicted and as described with respect to FIG. 5, the canvas virtual space 406 may be generated.

As an illustrative example, the canvas virtual space 406 relates to a business interaction and upcoming meeting with “ABC Corp.” Each tile 602-610 includes different types of content with respect to the meeting with ABC Corp. For instance, tile 602 provides a list or summary of meeting goals, tile 604 includes financial information relating to ABC Corp, tile 606 is related to a pain points analysis for ABC Corp, tile 608 relates to an account overview of ABC Corp, and tile 610 relates to an opportunity analysis recap for ABC Corp. The tiles 602-610, and the content within each of the tiles 602-610 may be obtained from multiple different sources using the model(s) 416, including generative AI models and/or large language models. That is, the model(s) 416 may learn over time which information is relevant to various requests, text input, prompts, etc. from a user, then automatically create tiles 602-610 relating to different aspects of the topic of the canvas virtual space 406, and then populate each of the tiles 602-610 with content relevant to each one of the tiles 602-610.

Accordingly, the canvas virtual space 406 may provide dynamic and up to date information on a particular account, project, topic, event, etc. For instance, the dynamically provided content within the canvas virtual space 406 may help prepare for a meeting by automatically obtaining, aggregating, and displaying key contextual data from various sources (e.g., external documents, internal documents, group-based communication platforms, calendars, websites, etc.) using one or more generative AI models to summarize relevant information, such as meeting notes, and creating action items for next steps. The canvas virtual space 406 may be dynamically updated as new or updated information becomes available from the different sources, and/or as the user requests additional information. Such requests may include questions or prompts input via the chat interface 420. As a result, this may allow all of the relevant content to be displayed in a single location (e.g., the canvas virtual space 406) and may allow the user to have a more comprehensive and holistic understanding of an issue.

In some embodiments, the user may reposition, move, adjust the size of, etc. the tiles (ref. nos. 602-610) and/or content within the canvas virtual space 406. The system may store the data regarding the orientation, size, layout, etc. of the components, sections, and/or content and then present canvas virtual spaces 406 for different topics in a similar manner. That is, the system and/or the model(s) 416 may learn patterns regarding prompts of the user, the manner in which the user adjusts the tiles (ref. nos. 602-610) and/or content within the canvas virtual space 406, preferences of the user (e.g., likes, dislikes, etc.). The system may also display the tiles (ref. nos. 602-610) and/or content within a canvas virtual space 406 based on other users that have a similar role or position as the user, with respect to an organization or employer of the user.

The following is an illustrative example with respect to FIGS. 4-10. Assume that Emy is an account executive at XYZ Co. and she is trying to do their best to close the fiscal year by beating their assigned quota. However, she still has some work to do to meet the assigned quota and she needs to take advantage of any potential opportunities. Emy elects to use a canvas virtual space 406 to prepare effectively for her upcoming meetings with key stakeholders from ABC Corp. There is an upcoming meeting with ABC Corp that is critical to meeting their quota. Upon accessing the user interface 500 illustrated in FIG. 5, Emy is presented with suggested prompts 502 that she can use to generate a canvas virtual space 406. In addition, via the chat interface 420, Emy is able to provide text input to generate the canvas virtual space 406, such as “help me prepare for my meeting with ABC Corp.” Upon entering text within the chat interface 420 or selecting one of the suggested prompts 502, the generated canvas virtual space 406 may provide proactive recommendations that Emy can start using to prepare for the upcoming meeting(s). If the canvas virtual space 406 has already been created, and possibly already accessed by Emy, the canvas virtual space 406 will be dynamically updated to reflect real-time information and suggestions for Emy.

The canvas virtual space 406 includes a plethora of different relevant information relating to ABC Corp, including different tiles directed to an ABC Corp account recap, key statistics relating to ABC Corp, meeting information regarding the upcoming meeting(s), key stakeholders that will be attending the upcoming meeting(s), profiles of the attendees of the upcoming meeting(s), and so on. Instead of accessing emails or internal documents to get caught up on the account recap, visiting ABC Corp's website to obtain information about the company, accessing her calendar to view meeting details regarding the meeting, and visiting a website (e.g., LinkedIn®) to obtain information about the different stakeholders, Emy need only visit the canvas virtual space 406 to view all of this information in a single source.

After viewing the canvas virtual space 406, Emy is intrigued by a prompt suggesting her to get the news on the account. Emy clicks on the prompt and finds out that the canvas virtual space 406 generates a UI card which provides insightful news. Emy then discovers that ABC Corp has announced an acquisition of a smaller competitor in this space, which could provide an upsell opportunity for Emy. Next, Emy wishes to review the call transcripts from the last few calls with ABC Corp and review the action items that resulted from the calls, especially since Emy missed the last meeting with ABC Corp. The card, generated by the model(s) 416, shows Emy that one of the action items was to review the existing sales license usage across their respective organizations and identify areas where the customer can save resources. Emy clicks on the action item and the model(s) 416 generate insights on the adoption of a product with links to corresponding reports that Emy can obtain, if needed. Given that ABC Corp is acquiring another company and the key stakeholder is likely looking to review the licenses, Emy determines that the next best course of action is to upsell the licenses since ABC Corp will likely need new licenses as they bring in the personnel from the acquired company. Based on the next best action, Emy prepares the proposal for the upcoming meeting.

As the meeting starts, one of the stakeholders of ABC Corp asks Emy that, before they could review the proposal, they want to hear an update on the top cases that have been opened for greater than a month. Emy quickly access the canvas virtual space 406 and use the chat interface 420 to create a case summary of the top cases on the account. To Emy's relief, the canvas virtual space 406 not only provides the summary of the top cases, but also includes notes on the resolution of each case. As a result of the canvas virtual space 406, Emy is successfully able to share the updates with the stakeholder at ABC Corp. Next, Emy provides an overview of the product adoption and also suggests to the stakeholder and their team that, since ABC Corp is acquiring their competitor, ABC Corp should take advantage of the end of the quarter discount that XYZ Co. is offering.

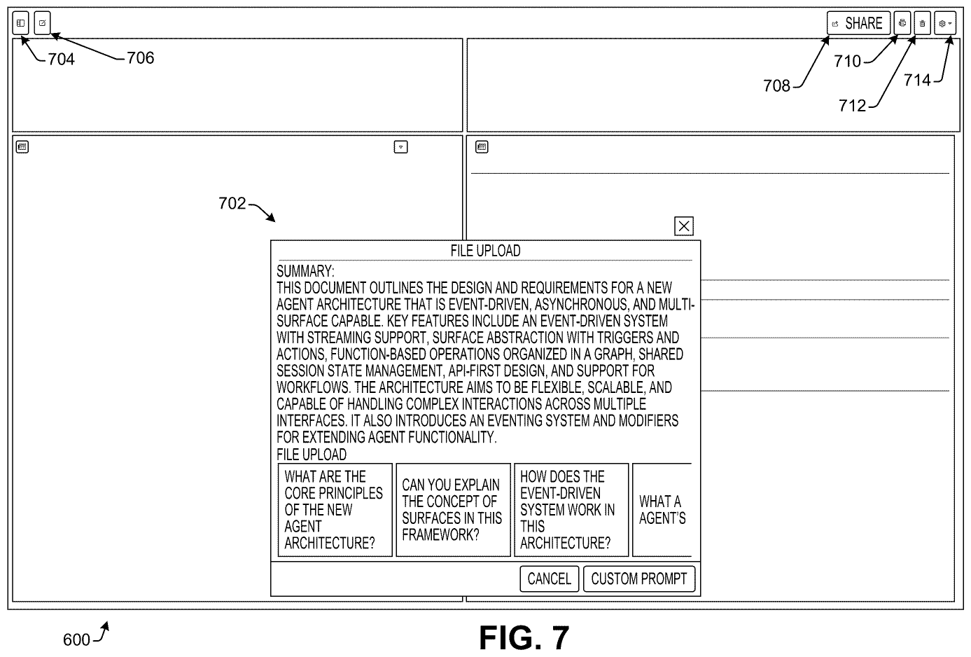

FIG. 7 illustrates the user interface 600 as depicted in FIG. 6, but the text within each of the tiles 602-610 has been removed for the sake of simplicity. In FIG. 7, the user interface includes a file upload tile or section 702 that enables a user to upload a file or document (e.g., a Word document, a PDF file, a PowerPoint presentation, .txt files, etc.) to the canvas virtual space 406. Upon the file/document being uploaded, the model(s) 416 may provide a summary of the file/document within a portion of the canvas virtual space 406. Moreover, the canvas virtual space 406 may provide suggestions for modifying the document and may help the user understand the key questions someone might ask in the context of the file/document. As shown, the file upload tile 702 includes a summary of the file/document that has been uploaded, as well as example questions that one may ask with respect to the file/document. In addition, the user may cancel out of the file upload tile 702 or input a custom prompt or question regarding the content of the document (or the provided summary).

Although not depicted in FIG. 6, the user interface 600 may include a toolbar 704 that may allow a user to toggle or switch between different layouts of the canvas virtual space 406 or between different canvas virtual spaces 406. A user may also utilize the toolbar 704 to create a new layout for the canvas virtual space 406 depicted in the user interface 600. The user interface 600 may also include a selectable control 706 to allow the user to navigate from a specific canvas virtual space 406 to a general canvas virtual space 406. Moreover, the user interface 600 may include a sharing function 708 that allows a user to chare the canvas virtual space 406 with other users, such that the other users then have access to the canvas virtual space 406. The sharing function 708 may also allow the user to change one or more privacy settings from private to public so that the canvas virtual space 406 is visible and/or editable by other users, and vice versa. The user interface 600 may additionally include a suggested prompts control 710 that allows the user to request or provide suggested prompts that will cause the modification of tiles (or content within the tiles), or may cause the addition or removal of tiles (or content within the tiles). A delete control 712 may allow the user to delete the canvas virtual space 406 and a settings control 714 may offer different settings with respect to the canvas virtual space 406.

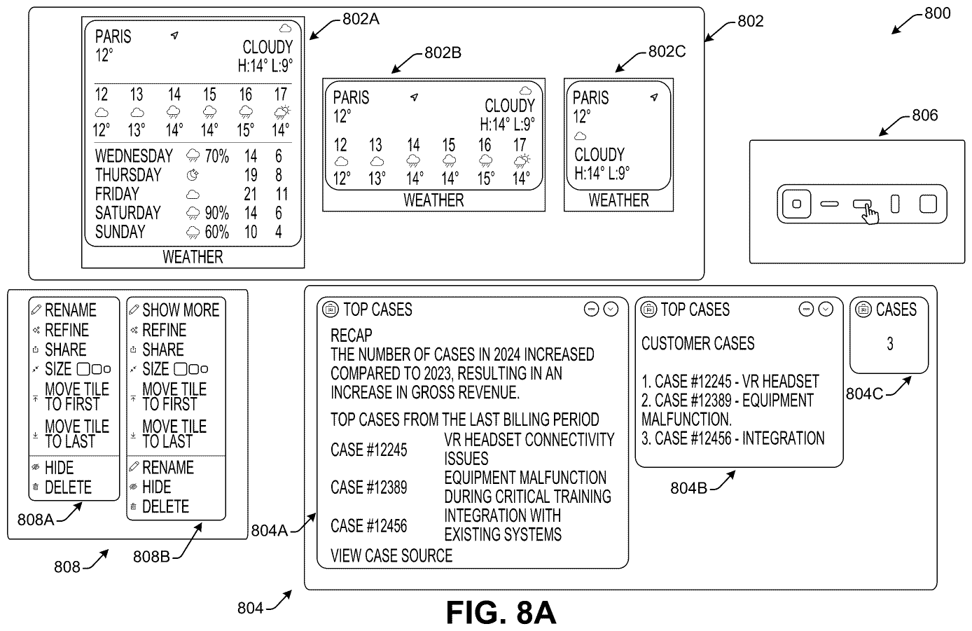

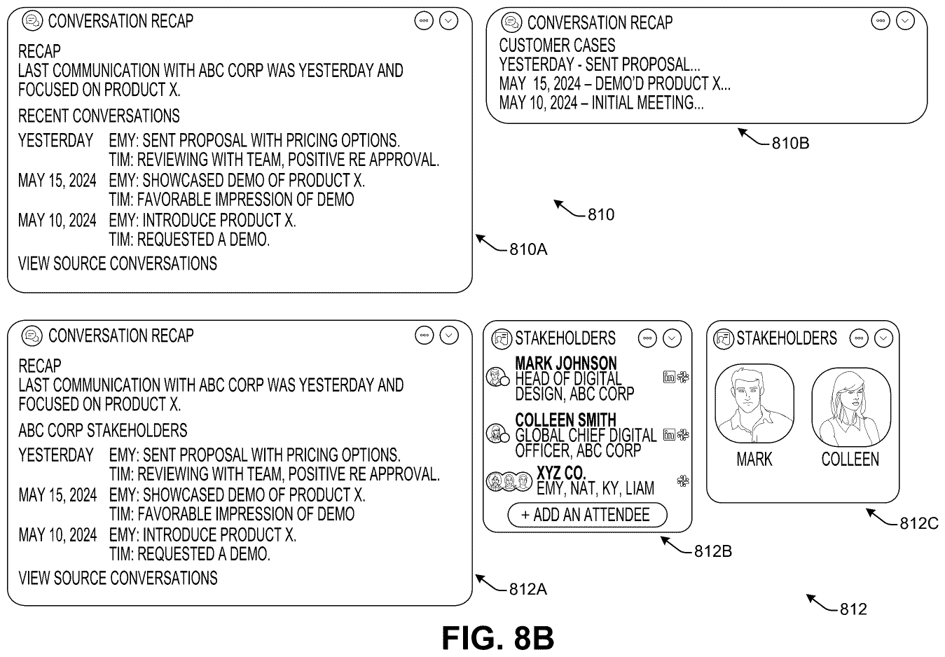

FIG. 8A illustrates a diagram 800 that illustrates various layouts and orientations for tiles within the canvas virtual space 406. In some embodiments, the user may adjust the size and/or location of the tiles (or otherwise referred to as components or sections) within the canvas virtual space 406 while retaining the same content within the tiles. However, in other embodiments, and as illustrated in FIG. 8A, the user may adjust the density and/or complexity of the content within different tiles of the canvas virtual space 406. For instance, as the user reduces the size of a tile, the content within the tile may dynamically become more abstract and more summarized. The user may manually reduce the size of the tile to adjust the abstraction of the content, or the user may select between different layouts, where each of the layouts has a different size and a corresponding different level of detail of the content. As the size of the tile becomes smaller, the level of abstraction of the corresponding content may increase, and vice versa. That is, as the size of the tile decreases, the level of detail of the content also decreases, such as less information being displayed, a summary of the information being displayed, and so on. The model(s) 416 may determine, and cause display of, the appropriate content when the tile is either increased or decreased.

Tile 802 depicts different versions of content associated with the weather in Paris. The user may select between different versions of the tile 802 in order to control the amount of content that is displayed within the tile 802. A first version 802A of the tile 802 shows the current weather in Paris, predicted weather during that particular day, and a weather forecast for the remainder of the week. Based on preferences of the user in view of previous actions taken by the user, or via a user selection to reduce the size of the tile 802, a more condensed second version 802B of the tile 802 may be displayed, where the tile 802 still shows information about the current weather in Paris, but a more condensed version. For instance, the second version 802B depicts the current weather Paris, as well as a prediction of the weather throughout the day, but the second version 802B omits the daily forecast for Paris for the remainder of the week. Similarly, a third version 802C of the tile 802 only shows the current weather conditions in Paris, without illustrating the likely upcoming weather throughout the day and without including the weather forecast for the remainder of the week. Accordingly, the user may choose how much information they would like to view in tile 802. In some embodiments, the different versions of the tile 802 may be any number and may be preset or predetermined, such that the user need only select one of the versions for viewing within the canvas virtual space 406. However, in other embodiments, the user may elect to gradually adjust the size of the tile 802 and, as the tile 802 becomes smaller, a more condensed version of the content (e.g., the weather in Paris) is shown. Likewise, as the user increases the size of the tile 802, additional content is shown and the content becomes more robust. For instance, although only three versions are shown for the sake of simplicity, provided that the user is viewing version 802A, enlarging the version 802A may result in an additional version of the tile 802 that illustrates weather in the surround area, historical weather conditions for comparison sake, and so on. Similarly, if the user is currently viewing version 8C, further reducing the size of the tile 802 may cause the tile 802 to only show “Paris” and a symbol of a cloud, representing the current weather conditions. In some embodiments, the model(s) 416 are determining the amount of content, and what content in particular, to include within the different versions of the tiles based on the relative size of the tile. The model(s) 416 make such a determination based on being trained on data indicating previous tiles, the content included therein, preferences of users, and the amount and type of content included within the tiles when the tiles are increased and/or decreased.

As a further example, similar to tile 802, tile 804 also displays different versions corresponding to the amount of content displayed within each version. Tile 804 relates to the top customer cases for a particular year. In version 804A of tile 804, additional content is displayed, as compared to versions 804B and 804C. For instance, version 804A of tile 804 provides a recap of cases in 2024, as well as a list of three top cases and a summary of each, and an option to view a “case source.” The user may elect to view a second version 804B of tile 804 where a lesser amount of information is displayed. Here, the second version 804B only shows the top three cases with a limited amount of description, as compared to the first version 804A. A more condensed version 804C shows even less information, such as the number of top cases (e.g., “3”). The user may toggle between each of the versions based on how much information the user would prefer to view.

Tile 806 may be presented to the user via the canvas virtual space 406, and may represent the ability of the user to select different sizes, versions, or formats of tiles. For instance, instead of the user having to manually adjust the size or layout of a tile, the user can select predetermined sizes for the tiles. Upon selecting a particular size/layout of a tile, the model(s) 416 may determine the appropriate amount and type of content to include within that selected size/layout of the tile. That way, the user need not bother with determining the size and configuration of a tile, and merely may select a size/layout that is consistent with the amount of content that they would like to view. The user also is not limited to one of the sizes/layouts, and may toggle between different sizes/layouts to view different granularities of detail of the content.

Tile 808 displays ways in which the user can adjust parameters associated with a tile. The options presented with tile 808 may be presented to the user via the canvas virtual space 406 and may correspond to both manual and preset ways in which the user can adjust the size/layout of a tile, as well as the amount of content to be included within a tile. For instance, in version 808A, the user may be able to rename the tile 808, refine the amount of content to include within the tile 808 (or refine the type of content to include within the tile 808), share the tile 808 with one or more other users, adjust the size or layout of the tile 808 between preset sizes/layouts, move the tile 808 to first such that the tile 808 is shown first in the canvas virtual space 406 before other tiles, and/or move the tile 808 to last such that the tile 808 is presented last in the canvas virtual space 406 as compared to other tiles in the canvas virtual space 406. The user may also be able to hide the tile 808 from view or delete the tile 808 such that it will not be displayed in conjunction with the canvas virtual space 406. It is contemplated that some or all of such functions may be presented to the user. Version 808B shows a different version of 808A with many of the same functions/operations, as well as a show more function that allows the user to view additional and/or different options regarding ways in which the user can adjust the size, layout, type, etc., of the tile 808.

FIG. 8B is a continuation of FIG. 8A and depicts additional examples of how the size/layout of tiles can be adjusted, which dictates the amount of content included within the tiles. Tile 810A corresponds to a conversation recap regarding business negotiations between individuals and/or organizations. In version 810A, a more detailed version of the content is displayed, including a recap of the conversations, and a relatively detailed list of conversations that occurred on different days. The user may also select to view the source of the conversations. In a more condensed version 810B of the tile 810, only a shortened/abbreviated version of the recent conversations is displayed. The user may toggle between the different versions, expand or shrink the tile 810 to view even more or less content, respectively. The amount and type of content to be included within the tile 810, regardless of the currently selected size/layout of the tile 810 is determined by the model(s) 416, such as LLMs, generative AI models, machine-learned models, and so on.

In an additional example, tile 812 is similar to tile 810, except version 812A of tile 812 includes stakeholders of ABC Corp that are listed in the summary of recent conversations. If the user is interested more in viewing information about the stakeholders, a more condensed version 812B of the tile 812 lists the stakeholders referenced in the recent conversations section, including the names of the stakeholders, their position, and/or the organization that they are associated with. For example, version 812B indicates that “Mark Johnson” is the “Head of Digital Design” at “ABC Corp,” that “Colleen Smith” is the “Global Chief Digital Officer” of “ABC Corp,” and “Emy,” “Nat,” “Ky,” and “Liam” are part of “XYZ Co.” If the user would like to further reduce the amount of content included within tile 812 and correspondingly increase the level of abstraction, the user may adjust the size/layout of tile 812 to version 812C, which only illustrates an image of two of the stakeholders (e.g., “Mark” and “Colleen”) and their first names. Additional versions of tile 812 may also be preferred by the user, such as a version having an additional amount of content, such as a more detailed summary of the recent conversations. On the other hand, a more condensed version of tile 812 may only include an image depicting the stakeholders (without their names) or just the names of the stakeholders (without the corresponding images).

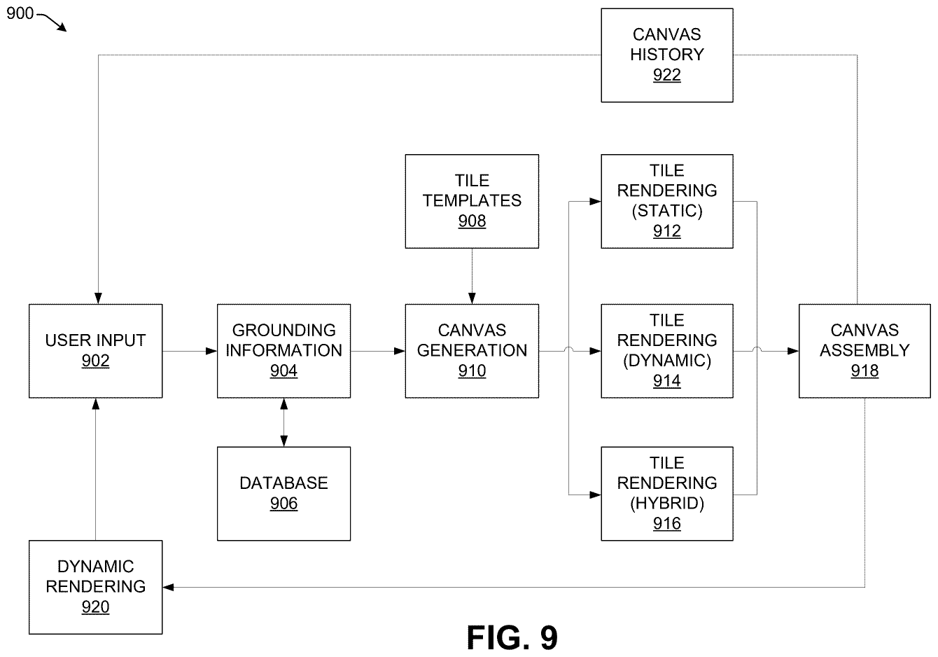

FIG. 9 illustrates a diagram representing a process for generating a canvas virtual space 406 associated with a service provider and dynamically rendering tiles within the canvas virtual space 406. Initially, the service provider may receive user input 902 from a user regarding the creation of, or to access, a canvas virtual space 406. For instance, the user may input text via the chat interface 420 or select one of the suggested prompts 502. As a result, the model(s) 416 may automatically generate the canvas virtual space 406 and automatically render tiles to be displayed within the canvas virtual space 406, where the tiles are associated with a different aspect of a topic associated with the canvas virtual space 406 and each of the tiles include content consistent with each of the tiles. In some embodiments, once the canvas virtual space 406 is generated, the user may add tiles to the canvas virtual space 406.

After receiving the user input 902, the service provider may obtain grounding information 904 associated with the user. For the purposes of this discussion the grounding information 904 may correspond to data/information currently known about the user, such as their position/role within an organization, previous actions taken by the user, accounts the user has worked on, previous canvas virtual spaces 406 generated by, or accessed by, the user, and any other information/data that may be helpful to utilize, by the model(s) 416, to generate and dynamically update the canvas virtual space 406. In some embodiments, the grounding information 904 is retrieved from a database 906 maintained by the service provider.

Based on the grounding information 904 and one or more tile templates 908, the canvas virtual space 406 may be generated (e.g., “canvas generation 910”) by the model(s) 416. The tile templates 908 may be templates that indicate how the tiles that are to be included within the canvas virtual space 406 are to be displayed, including a size, layout, and orientation of the tiles within the canvas virtual space 406.

Upon canvas generation 910, the tiles may be rendered to be displayed within the canvas virtual space 406. In some embodiments, the tiles may be rendered statically (e.g., “tile rendering (static) 912”), the tiles may be rendered dynamically (e.g., “tile rendering (dynamic) 914”), or the tiles may be rendered both statically and dynamically (e.g., “tile rendering (hybrid) 916”). In static rendering, the tiles may be rendered over predetermined time periods and, via dynamic rendering, the tiles may be rendered in real-time as the user navigates the canvas virtual space 406, as the user requests modifications, additions, or deletions to the canvas virtual space 406, and/or as new or updated data relevant to the canvas virtual space 406 is identified.

After the appropriate tiles are identified and rendered by the model(s) 416, the canvas virtual space 406 may be assembled (e.g., “canvas assembly 918”) for rendering to the user and the canvas virtual space 406 may be dynamically rendered 920 to the user. A canvas history 922 associated with the canvas virtual space 406 may be retained and stored by the service provider for the purpose of subsequently updating the newly generated canvas virtual space 406, or to assist in creating new canvas virtual spaces 406 for the user, and possibly other users.

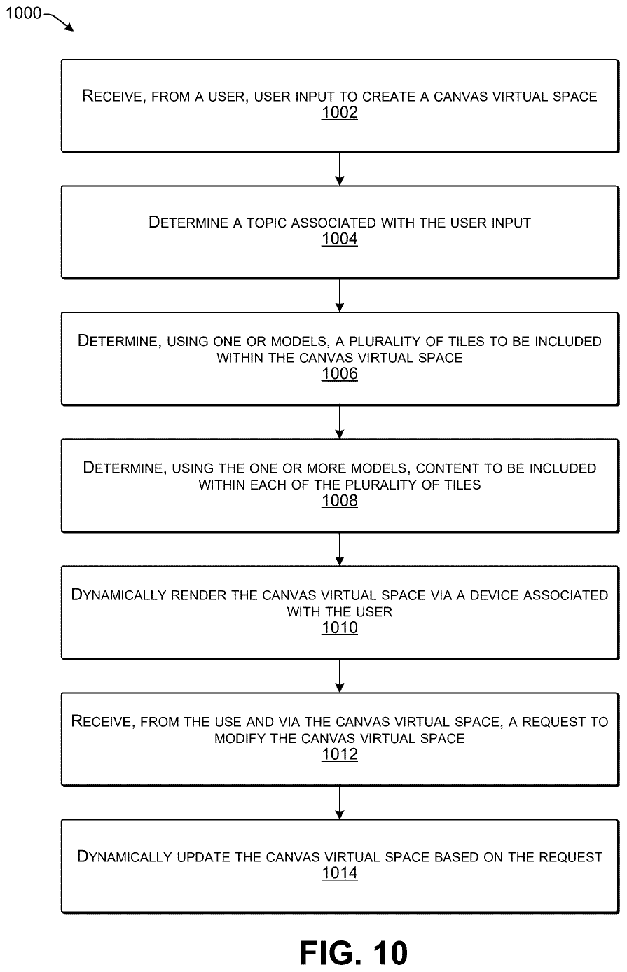

FIG. 10 is a flow diagram illustrating an example process of generating a canvas virtual space 406, including tiles relating to different aspects of a topic associated with the canvas virtual space 406 and relevant content included within each of the tiles. The processes illustrated in FIG. 10 is described with reference to components described above with reference to the example environments shown in FIGS. 1-9 for convenience and ease of understanding. However, the processes illustrated in FIG. 10 is not limited to being performed using the components described above with reference to the example environments described herein. Moreover, the components described above with reference to the example environments described herein are not limited to performing the processes illustrated in FIG. 10.

Process 1000 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At 1002, a user input is received from a user to create a canvas virtual space. In some embodiments, the user input may include text (or other information) input via the chat interface 420 displayed within a user interface accessible via a user device of the user. In other embodiments, the user input may be the selection of a suggested prompt 502 for generating a canvas virtual space 406.

At 1004, a topic associated with the user input is determined. For instance, upon receiving the user input, whether the user input includes user inputted text or the selection of a suggested prompt 502, the model(s) 416 associated with the service provider may parse the user input to determine a topic associated with the user input. The topic may be the central theme of the canvas virtual space 406.

At 1006, a plurality of tiles to be included within the canvas virtual space are determined using one or more models. Each of the plurality of tiles corresponds to a different aspect of the topic such that the resulting canvas virtual space 406 includes various types of information that are relevant to the topic. The model(s) 416 may leverage various types of data to determine tiles/aspects that are related to, and that represent, the topic.

At 1008, content to be included within each of the plurality of tiles is determined using the one or more models. Assuming that each tile corresponds to a different aspect of the topic, the content included within each of the tiles is relevant to the aspect in which the tile is associated with. The model(s) 416 may be utilized identify content, from multiple different sources (e.g., internal documents, external documents, websites, calendar data, email data, group-based communication platform data), that is relevant to the topic and the user.

At 1010, the canvas virtual space is dynamically rendered via a device associated with the user. Once the topic, tiles, and content within the tiles have been determined, all of this information may be dynamically presented via the canvas virtual space 406, such that the user can access a single source to view data associated with the topic, as opposed to being forced to navigate, and toggle between, multiple different sources.

At 1012, a request to modify the canvas virtual space is received from the user via the canvas virtual space. For instance, the user may request that tiles be added, modified, or deleted. Or, the user may request that additional, different, or less content be included in individual ones of the tiles. The user may also request that a size or layout of the tiles be adjusted, or that the tiles be reconfigured with respect to one another. As a result, the user may adjust the layout or configuration of the canvas virtual space 406 based on their preferences.

At 1014, the canvas virtual space is dynamically updated based on the request. Upon receiving the request, the model(s) 416 may determine how the canvas virtual space 406 is to be updated and, in response, the canvas virtual space 406 may be dynamically updated by adding, removing, or updating tiles, adjusting the content included within tiles, adjusting the layout and/or size of the tiles, and so on. As a result, based on user input and/or new data being identified by the model(s) 416, the canvas virtual space 406 may be dynamically updated on an ongoing basis so that the most relevant and updated content associated with the topic is presented to the user.

### Example Clauses

The following clauses provide various examples of implementations of the present disclosure:
A: A method comprising: receiving, from a device of a user and via a first user interface, a request; determining, based at least in part on the request, a topic that is responsive to the request; determining, based at least in part on the topic and using one or more models, a plurality of tiles that each correspond to a different aspect of the topic; determining, using the one or more models, content to be included within the plurality of tiles; dynamically rendering the plurality of tiles and the content within the plurality of tiles within a second user interface, wherein the plurality of tiles are of different sizes and are arranged in a first layout; and causing presentation of the second user interface via the device of the user.
B: The method as recited in paragraph A, wherein the request is at least one of: one or more words input via a text entry field; or a selection of a suggested prompt of a plurality of selectable suggested prompts that are displayed via the first user interface.
C: The method as recited in paragraph A, wherein the one or more models include one or more generative artificial intelligence models or one or more large language models.
D: The method as recited in paragraph A, further comprising: causing second presentation of a tile of the plurality of tiles in a first size, the tile including a first amount of content; receiving, from the user and via the second user interface, a second request to modify the first size of the tile to a second size; and dynamically modifying, based at least in part on the second request, the tile from the first size to the second size, wherein the tile in the second size includes a second amount of content that is less than or greater than the first amount of content.
E: The method as recited in paragraph A, further comprising: receiving, from the user and via the second user interface, a second request to upload a file or document; causing, based at least in part on the second request, the file or the document to be uploaded; generating, using the one or more models, a summary of the file or the document and one or more questions relating to the file or the document; and dynamically rendering, via a tile within the second user interface, the summary of the file or the document and the one or more questions.
F: The method as recited in paragraph A, wherein the second user interface is presented to the device of the user at a first time, further comprising: determining, at a second time that is subsequent to the first time and using the one or more models, additional data determined to be relevant to the topic; and one of: adding the additional data to one of the plurality of tiles; or adding a new tile to the second user interface, wherein the new tile includes the additional data.
G: The method as recited in paragraph A, further comprising: receiving, from the user and via the second user interface, a second request to rearrange one or more tiles of the plurality of tiles from a first size or the first layout to a second size or a second layout; and dynamically updating, based at least in part on the second request, the one or more tiles within the second user interface to be arranged in the second size or the second layout.
H: A system comprising: memory; one or more processors; and one or more computer-executable instructions stored in the memory and executable by the one or more processors to perform operations comprising: receiving, from a device of a user and via a first user interface, a request; determining, based at least in part on the request, a topic that is responsive to the request; determining, based at least in part on the topic and using one or more models, a plurality of tiles that each correspond to a different aspect of the topic; determining, using the one or more models, content to be included within the plurality of tiles; dynamically rendering the plurality of tiles and the content within the plurality of tiles within a second user interface, wherein the plurality of tiles are of different sizes and are arranged in a first layout; and causing presentation of the second user interface via the device of the user.
I: The system as recited in paragraph H, wherein the request is at least one of: one or more words input via a text entry field; or a selection of a suggested prompt of a plurality of selectable suggested prompts that are displayed via the first user interface.
J: The system as recited in paragraph H, wherein the one or more models include one or more generative artificial intelligence models or one or more large language models.
K: The system as recited in paragraph H, wherein the operations further comprise: causing second presentation of a tile of the plurality of tiles in a first size, the tile including a first amount of content; receiving, from the user and via the second user interface, a second request to modify the first size of the tile to a second size; and dynamically modifying, based at least in part on the second request, the tile from the first size to the second size, wherein the tile in the second size includes a second amount of content that is less than or greater than the first amount of content.
L: The system as recited in paragraph H, wherein the operations further comprise: receiving, from the user and via the second user interface, a second request to upload a file or document; causing, based at least in part on the second request, the file or the document to be uploaded; generating, using the one or more models, a summary of the file or the document and one or more questions relating to the file or the document; and dynamically rendering, via a tile within the second user interface, the summary of the file or the document and the one or more questions.
M: The system as recited in paragraph H, wherein the second user interface is presented to the device of the user at a first time, and wherein the operations further comprise: determining, at a second time that is subsequent to the first time and using the one or more models, additional data determined to be relevant to the topic; and one of: adding the additional data to one of the plurality of tiles; or adding a new tile to the second user interface, wherein the new tile includes the additional data.
N: The system as recited in paragraph H, wherein the operations further comprise: receiving, from the user and via the second user interface, a second request to rearrange one or more tiles of the plurality of tiles from a first size or the first layout to a second size or a second layout; and dynamically updating, based at least in part on the second request, the one or more tiles within the second user interface to be arranged in the second size or the second layout.
O: One or more non-transitory computer-readable media storing one or more computer-executable instructions that, when executed by one or more processors, cause the one or more processors to perform operations comprising: receiving, from a device of a user and via a first user interface, a request; determining, based at least in part on the request, a topic that is responsive to the request; determining, based at least in part on the topic and using one or more models, a plurality of tiles that each correspond to a different aspect of the topic; determining, using the one or more models, content to be included within the plurality of tiles; dynamically rendering the plurality of tiles and the content within the plurality of tiles within a second user interface, wherein the plurality of tiles are of different sizes and are arranged in a first layout; and causing presentation of the second user interface via the device of the user.
P: The one or more non-transitory computer-readable media as recited in paragraph O, wherein the request is at least one of: one or more words input via a text entry field; or a selection of a suggested prompt of a plurality of selectable suggested prompts that are displayed via the first user interface.
Q: The one or more non-transitory computer-readable media as recited in paragraph O, wherein the one or more models include one or more generative artificial intelligence models or one or more large language models.
R: The one or more non-transitory computer-readable media as recited in paragraph O, wherein the operations further comprise: causing second presentation of a tile of the plurality of tiles in a first size, the tile including a first amount of content; receiving, from the user and via the second user interface, a second request to modify the first size of the tile to a second size; and dynamically modifying, based at least in part on the second request, the tile from the first size to the second size, wherein the tile in the second size includes a second amount of content that is less than or greater than the first amount of content.
S: The one or more non-transitory computer-readable media as recited in paragraph O, wherein the operations further comprise: receiving, from the user and via the second user interface, a second request to upload a file or document; causing, based at least in part on the second request, the file or the document to be uploaded; generating, using the one or more models, a summary of the file or the document and one or more questions relating to the file or the document; and dynamically rendering, via a tile within the second user interface, the summary of the file or the document and the one or more questions.
T: The one or more non-transitory computer-readable media as recited in paragraph O, wherein the second user interface is presented to the device of the user at a first time, and wherein the operations further comprise: determining, at a second time that is subsequent to the first time and using the one or more models, additional data determined to be relevant to the topic; and one of: adding the additional data to one of the plurality of tiles; or adding a new tile to the second user interface, wherein the new tile includes the additional data.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, from a device of a user and via a first user interface, a request;
determining, based at least in part on the request, a topic that is responsive to the request;
determining, based at least in part on the topic and using one or more models, a plurality of tiles that each correspond to a different aspect of the topic;
determining, using the one or more models, content to be included within the plurality of tiles;
dynamically rendering the plurality of tiles and the content within the plurality of tiles within a second user interface, wherein the plurality of tiles are of different sizes and are arranged in a first layout; and
causing presentation of the second user interface via the device of the user.

2. The method as recited in claim 1, wherein the request is at least one of:
one or more words input via a text entry field; or
a selection of a suggested prompt of a plurality of selectable suggested prompts that are displayed via the first user interface.

3. The method as recited in claim 1, wherein the one or more models include one or more generative artificial intelligence models or one or more large language models.

4. The method as recited in claim 1, further comprising:
causing second presentation of a tile of the plurality of tiles in a first size, the tile including a first amount of content;
receiving, from the user and via the second user interface, a second request to modify the first size of the tile to a second size; and
dynamically modifying, based at least in part on the second request, the tile from the first size to the second size, wherein the tile in the second size includes a second amount of content that is less than or greater than the first amount of content.

5. The method as recited in claim 1, further comprising:
receiving, from the user and via the second user interface, a second request to upload a file or document;
causing, based at least in part on the second request, the file or the document to be uploaded;
generating, using the one or more models, a summary of the file or the document and one or more questions relating to the file or the document; and
dynamically rendering, via a tile within the second user interface, the summary of the file or the document and the one or more questions.

6. The method as recited in claim 1, wherein the second user interface is presented to the device of the user at a first time, further comprising:
determining, at a second time that is subsequent to the first time and using the one or more models, additional data determined to be relevant to the topic; and
one of:
adding the additional data to one of the plurality of tiles; or
adding a new tile to the second user interface, wherein the new tile includes the additional data.

7. The method as recited in claim 1, further comprising:
receiving, from the user and via the second user interface, a second request to rearrange one or more tiles of the plurality of tiles from a first size or the first layout to a second size or a second layout; and
dynamically updating, based at least in part on the second request, the one or more tiles within the second user interface to be arranged in the second size or the second layout.

8. A system comprising:
memory;
one or more processors; and
one or more computer-executable instructions stored in the memory and executable by the one or more processors to perform operations comprising:
receiving, from a device of a user and via a first user interface, a request;
determining, based at least in part on the request, a topic that is responsive to the request;
determining, based at least in part on the topic and using one or more models, a plurality of tiles that each correspond to a different aspect of the topic;
determining, using the one or more models, content to be included within the plurality of tiles;
dynamically rendering the plurality of tiles and the content within the plurality of tiles within a second user interface, wherein the plurality of tiles are of different sizes and are arranged in a first layout; and
causing presentation of the second user interface via the device of the user.

9. The system as recited in claim 8, wherein the request is at least one of:
one or more words input via a text entry field; or
a selection of a suggested prompt of a plurality of selectable suggested prompts that are displayed via the first user interface.

10. The system as recited in claim 8, wherein the one or more models include one or more generative artificial intelligence models or one or more large language models.

11. The system as recited in claim 8, wherein the operations further comprise:
causing second presentation of a tile of the plurality of tiles in a first size, the tile including a first amount of content;
receiving, from the user and via the second user interface, a second request to modify the first size of the tile to a second size; and
dynamically modifying, based at least in part on the second request, the tile from the first size to the second size, wherein the tile in the second size includes a second amount of content that is less than or greater than the first amount of content.

12. The system as recited in claim 8, wherein the operations further comprise:
receiving, from the user and via the second user interface, a second request to upload a file or document;
causing, based at least in part on the second request, the file or the document to be uploaded;
generating, using the one or more models, a summary of the file or the document and one or more questions relating to the file or the document; and
dynamically rendering, via a tile within the second user interface, the summary of the file or the document and the one or more questions.

13. The system as recited in claim 8, wherein the second user interface is presented to the device of the user at a first time, and wherein the operations further comprise:
determining, at a second time that is subsequent to the first time and using the one or more models, additional data determined to be relevant to the topic; and
one of:
adding the additional data to one of the plurality of tiles; or
adding a new tile to the second user interface, wherein the new tile includes the additional data.

14. The system as recited in claim 8, wherein the operations further comprise:
receiving, from the user and via the second user interface, a second request to rearrange one or more tiles of the plurality of tiles from a first size or the first layout to a second size or a second layout; and
dynamically updating, based at least in part on the second request, the one or more tiles within the second user interface to be arranged in the second size or the second layout.

15. One or more non-transitory computer-readable media storing one or more computer-executable instructions that, when executed by one or more processors, cause the one or more processors to perform operations comprising:
receiving, from a device of a user and via a first user interface, a request;
determining, based at least in part on the request, a topic that is responsive to the request;
determining, based at least in part on the topic and using one or more models, a plurality of tiles that each correspond to a different aspect of the topic;
determining, using the one or more models, content to be included within the plurality of tiles;
dynamically rendering the plurality of tiles and the content within the plurality of tiles within a second user interface, wherein the plurality of tiles are of different sizes and are arranged in a first layout; and
causing presentation of the second user interface via the device of the user.

16. The one or more non-transitory computer-readable media as recited in claim 15, wherein the request is at least one of:
one or more words input via a text entry field; or
a selection of a suggested prompt of a plurality of selectable suggested prompts that are displayed via the first user interface.

17. The one or more non-transitory computer-readable media as recited in claim 15, wherein the one or more models include one or more generative artificial intelligence models or one or more large language models.

18. The one or more non-transitory computer-readable media as recited in claim 15, wherein the operations further comprise:
causing second presentation of a tile of the plurality of tiles in a first size, the tile including a first amount of content;
receiving, from the user and via the second user interface, a second request to modify the first size of the tile to a second size; and
dynamically modifying, based at least in part on the second request, the tile from the first size to the second size, wherein the tile in the second size includes a second amount of content that is less than or greater than the first amount of content.

19. The one or more non-transitory computer-readable media as recited in claim 15, wherein the operations further comprise:
receiving, from the user and via the second user interface, a second request to upload a file or document;
causing, based at least in part on the second request, the file or the document to be uploaded;
generating, using the one or more models, a summary of the file or the document and one or more questions relating to the file or the document; and
dynamically rendering, via a tile within the second user interface, the summary of the file or the document and the one or more questions.

20. The one or more non-transitory computer-readable media as recited in claim 15, wherein the second user interface is presented to the device of the user at a first time, and wherein the operations further comprise:
determining, at a second time that is subsequent to the first time and using the one or more models, additional data determined to be relevant to the topic; and
one of:
adding the additional data to one of the plurality of tiles; or
adding a new tile to the second user interface, wherein the new tile includes the additional data.
